(19) United States
(12) Patent Application Publication
(10) Pub. No.: US 2008/0243406 A1
(43) Pub. Date: Oct. 2, 2008

(54) Temporally aligned waveform processing

(75) Inventor: Peter James Pupalaikis, Ramsey, NJ (US)

Correspondence Address: LECROY CORPORATION, 700 CHESTNUT RIDGE ROAD, CHESTNUT RIDGE, NY, 10977, US

(73) Assignee: LeCroy Corporation, Chestnut Ridge, NY (US)

(21) Appl. No.: 11/906,658

(22) Filed: Oct. 3, 2007

Related U.S. Application Data
(60) Provisional application No. 60/908,355, filed on Mar. 27, 2007.
(60) Provisional application No. 60/915,352, filed on May 1, 2007.
(60) Provisional application No. 60/927,000, filed on May 1, 2007.

(51) Int. Cl. G06F 19/00

(52) U.S. Cl. 702/66

(57) ABSTRACT

Methods for processing waveforms may include using temporal descriptor information about an input waveform to selectively request a segment of the input waveform that, when processed by a filter, produces a segment of an output waveform. In an illustrative example, waveform descriptor information may be used to request data to perform unary or filtering operations, or to perform one or more processes that involve at least one additional waveform. In combination with a filter descriptor that identifies, for example, upsampling factor, delay samples, and startup samples, complex waveform operations may be processed by selectively pulling input waveform segment data to generate a segment of the output waveform. In embodiments that process sequential waveform segments, filter tap states may be initialized using state information from processing of a previous waveform segment.

This application claims priority to: U.S. patent application Ser. No. 09/988,416 to Miller et al., filed on Nov. 16, 2001, and entitled “Processing Web for Data Processing in a Digital Oscilloscope or Similar Instrument”; and, U.S. patent application Ser. No. 09/988,420 to Cake et al., filed on Nov. 16, 2001, and entitled “Processing Web Editor for Data Processing in a Digital Oscilloscope or Similar Instrument.”

This application also claims priority to: U.S. Provisional Patent Application Ser. No. 60/908,355 to Pupalaikis, filed on Mar. 27, 2007, entitled “Temporally Aligned Waveform Processing,”, and U.S. Provisional Patent Application Ser. No. 60/915,352 to Pupalaikis, filed on May 1, 2007, entitled “Temporally Aligned Waveform Processing” the entire contents of which are incorporated herein by reference.

### TECHNICAL FIELD

### Background

Digital processing of data may be applied in applications such as communications, control systems, audio processing, video data processing, and test and measurement, for example. In some cases, digital processing may involve digital filters that process sampled data acquired by an analog-to-digital converter (ADC). The sampled data may be processed by a digital signal processing (DSP) system, for example.

### SUMMARY

Methods for processing waveforms may include using temporal descriptor information about an input waveform to selectively request a segment of the input waveform that, when processed by a filter, produces a segment of an output waveform. In an illustrative example, waveform descriptor information may be used to request data to perform unary or filtering operations, or to perform one or more processes that involve at least one additional waveform. In combination with a filter descriptor that identifies, for example, upsampling factor, delay samples, and startup samples, complex waveform operations may be processed by selectively pulling input waveform segment data to generate a segment of the output waveform. In embodiments that process sequential waveform segments, filter tap states may be initialized using state information from processing of a previous waveform segment.

In some embodiments, input waveform data may be pulled based on waveform descriptor information that identifies a temporal offset, number of samples, and sample period associated with a portion of the input waveform. The method may further include determining buffer sizes for storing the requested input waveform segment. The filter may include a digital filter to process the requested input waveform data and to generate the output waveform data. Some filters may produce each output waveform segment data by processing segments from more than one input waveform.

Various embodiments may provide certain advantages. For example, filter tap initialization may substantially improve the performance of a pull architecture by reducing computational penalties associated with initializing digital (e.g., FIR, IIR) filters when processing contiguous segments that are adjacent in time. Moreover, such reduced penalties may reap the cache utilization (e.g., 100% cache hit processing) potential of processing data in a pull (e.g., demand) architecture. Furthermore, some embodiments may yield further performance advantages by processing substantially only the portions of the input waveform needed to generated the desired output waveform. In some examples, computational burdens associated with waveform processing may be substantially reduced for generalized waveforms by selecting relevant portions of an acquired waveform to be processed. Some embodiment may substantially reduce waveform processing time by selectively pulling and processing substantially only those portions of input waveforms that are used to generate a specified output waveform segment. Various embodiments may be adapted to process complex long chains of filtering elements within a processing component, where there may be more than one stream of data involved (e.g., two processed waveform streams are added at one point in the processing). Some embodiments may expeditiously handle processing of filter startup samples for each waveform segment, for example, while maintaining substantially high throughput performance. Some embodiments may also process waveforms having various rates along the processing chain (e.g., by incorporating upsamplers, downsamplers and/or multi-rate filters).

Various illustrative embodiments are described in the accompanying drawings and the description below. Further features and advantages will be apparent from the description and drawings, and from the claims.

### DESCRIPTION OF DRAWINGS

FIG. 1 shows an exemplary finite impulse response (FIR) filter structure.

FIG. 2 shows an exemplary integer delay symmetric linear phase FIR.

FIG. 3 shows an exemplary integer delay linear phase FIR.

FIG. 4 shows filter coefficients of an exemplary upsampling filter with an upsample factor of four.

FIG. 5 shows an exemplary polyphase upsampler configuration.

FIG. 6 shows an exemplary single-phase upsampler configuration.

FIG. 7 shows a block diagram for an exemplary waveform synchronization process.

FIG. 8 shows a block diagram for an exemplary waveform synchronization process with adaptors and resamplers.

FIG. 9 shows an exemplary algorithm for calculating waveform synchronizing resamplers and adaptors.

FIG. 10 shows an exemplary algorithm for determining processing requirements for a requested output segment.

FIG. 11 illustrates an exemplary process for deriving segment filtering instructions from a segment processing equation.

FIG. 12 shows an exemplary calculation showing exemplary processing requirements.

FIG. 13 shows an exemplary filtering requirements calculation.

FIG. 14 shows an exemplary algorithm as in FIG. 10 that further includes filter state optimization.

FIG. 15 shows an exemplary calculation as in FIG. 12 that further includes internal filter state optimization.

FIG. 16 shows an exemplary filtering requirements calculation for contiguous processing of a segment 1.

FIG. 17 shows an exemplary algorithm as in FIG. 14 that further includes an embodiment of input buffer caching.

FIG. 18 shows an exemplary filtering requirements calculation for contiguous processing of a segment 1 that further includes input buffer caching.

FIGS. 19A-19B show an exemplary timing scenario for an exemplary waveform processing system.

FIGS. 20A-20B illustrates steps of an exemplary process for a waveform processing system.

### DETAILED DESCRIPTION OF ILLUSTRATIVE EMBODIMENTS

Various embodiments may involve an architecture that may be referred to as a pull system. In one example, this may include a demand driven system in which data is processed based on the output requirements. Pull systems may be utilized for a number of reasons. For example, sometimes the output system needs to control the flow of input data. An exemplary pull system may be utilized in some applications to limit the amount of processing to areas of interest within the input data. In some DSP systems, for example, this may involve calculations of the input data that will be used to generate an output. The waveform processing in a digital oscilloscope is one example of a system that may benefit from a pull arrangement.

As an illustrative example, the streaming processing architecture of the LeCroy WAVEMASTER digital storage oscilloscope (DSO), available from LeCroy Corporation, is a system configured to pull data. Each waveform processing element in a chain of processors calculates the output waveform description based on the waveform description of an input waveform and the characteristics of the internal processing provided by the component, and provides waveform data at its output in segments only as each waveform segment is requested. The streaming architecture is designed specifically to pull the output waveform through the system segment by segment optimizing memory cache usage. Examples of a streaming architecture are described, for example, by Miller et al. in U.S. Pat. No. 6,539,318, “Streaming Architecture for Waveform Processing,” the Detailed Description and Figures of which are incorporated herein by reference.

In some examples, each processor in a processing chain may generally perform an operation, like implementing a single filter. A waveform processor including a single input waveform and a single filtering element may calculate the description of the output waveform and may calculate the filtering requirements to process segments of a particular output waveform. However, processing of multiple data streams may be complicated, for example, where each stream of data may not be symmetric. In some cases, data from each data stream may not be sampled simultaneously and therefore the sampling phase of the multiple data streams differs. In such situations, data may be resampled such that the data streams that are being combined are utilizing points sampled in the same phase.

The segmented processing of the output waveform presents unique problems in itself with regard to filter startup samples. Theoretically, when an output waveform segment is requested from a processor that is filtering a waveform, the input waveform segment that is filtered may contain the startup samples of the filter. This is most easily viewed from the standpoint of finite impulse response (FIR) filtering. When a FIR is utilized, the input waveform segment may contain the number of output points desired plus additional waveform points equal to the length of the FIR. This may lead to excessive processing of the waveform.

Some embodiments may process multiple filter rates with substantially efficient utilization of the internal filter states. Some embodiments may incorporate a mathematical system of abstraction that may substantially simplify calculation of filter effects on waveforms and that may further enable calculation of processing instructions for the efficient calculation of output waveform segments. In some examples, such a system may utilize this mathematical system to calculate processing effects of large chains of processing elements, some of which may include a variety of filtering rates. Some embodiments may use the calculation of processing effects of large chains of processing elements to insert additional elements or modify existing elements so as to substantially synchronize waveform portions where needed for binary and/or non-unary filter operations, for example. In some examples, such a system may calculate intermediate buffer segments for processing waveforms in segments. Some systems may substantially maintain the internal filter tap states to reduce or substantially minimize the amount of calculation needed to process contiguous waveform segments. In some embodiments, a system may buffer (e.g., cache) intermediate waveform portions, for example, to maintain internal filter states for optimal throughput.

An exemplary method incorporates a mathematical system for determining information needed for processing elements or processing chains with a level of abstraction suitable for efficient calculation. In various examples, this mathematical system uses the notion of pseudo-waveforms and pseudo-filters. A pseudo-waveform may be considered as an abstraction of an actual waveform that considers only information pertaining to time and points in the waveform and does not consider the waveform data points themselves. A pseudo-filter may be considered an abstraction of an actual filter that considers only information pertaining to its effect on time and points in input waveforms without regard to the effect of the filter on the input waveform data points.

This mathematical system may provide substantially simplified calculation of waveforms, waveform segments, waveform buffers, and the relationship between them. It may simplify the calculations of buffer, filter, filter state, and filter cache requirements.

Various embodiments may implement this or a similar mathematical system to describe the calculation of filtering instructions used in the processing of a waveform output segment in an efficient manner.

Next will be described an exemplary mathematical system that may be incorporated in some embodiments

Waveform data consists of an array of points that describe the magnitude of the waveform at each point. The waveform data, in itself, may not be sufficient to describe the waveform in a proper context. Generally, additional descriptor information may be used to describe the meaning of the waveform points from a time and magnitude standpoint. In the context of this system, the waveform points are described with regard to time and points. To describe the time of each point in the waveform, one needs to know the time of the first point along with the sample rate. The distance between each point is the sample period given by the reciprocal of the sample rate. The only additional piece of information that is needed is the number of points in the waveform. These three pieces of information describe the waveform from a time and points perspective. They include the horizontal offset (e.g., time of the first point), sample rate, and number of points.

In various examples, a FIR filter contains a given number of filter taps. In some systems, the filter taps may affect the size of the output waveform possible, and/or introduce delay. Finally, it will potentially change the sample rate of the input waveform (e.g., upsampling and downsampling, or decimation arrangements). These three pieces of information—startup samples, delay samples, and upsample factor—describe the affect that a filter can have on the waveform from a time and points perspective.

For embodiments with infinite impulse response (IIR) filters, the startup samples may be considered to be the number of input points required for the impulse response of the filter to settle to a level acceptably close to a threshold (e.g., zero). The startup samples associated with an IIR is the number of samples in the impulse response that would be used to generate an FIR that has settled acceptably.

Given the knowledge of the required information for waveforms and filters, an exemplary notation and nomenclature is introduced for describing waveforms and filters. The notation is presented to aid the reader and to clarify the description, but does not limit the scope of the embodiments contemplated.

The following description relates to exemplary waveform objects.

$$\{ \begin{matrix}H \\ N \\ Fs\end{matrix} \}$$

is a waveform with horizontal offset (H), a number of points (N) and a sample rate (Fs). The time of point nε[0,N−1] is given by

$$time [ n ] = H + \frac{n}{Fs} .$$

The horizontal offset is real and represents the time of the first point. The number of points is integer. The sample rate is real. {w} is a waveform named w. The horizontal offset, number of points, and sample rate of this waveform are written as {w}_{H}, {w}_{N} and {w}_{Fs}, respectively. Sometimes, this waveform may be written as

$$\{ \begin{matrix}{H}_{w} \\ \begin{matrix}{N}_{w} \\ {Fs}_{w}\end{matrix}\end{matrix} \} \cdot {\{ w \}}_{time ( i )}$$

may be defined as the time of the point at index i in the waveform {w}.

$$Time of a Waveform Point \\ {\{ w \}}_{time ( i )} ≡ {\{ w \}}_{H} + \frac{i}{{\{ w \}}_{Fs}} \qquad Equation 1$$

$${\{ w \}}_{index ( t )}$$

s the index of the point in the waveform with the time t.

$$Waveform Index for a Given Time \\ {\{ w \}}_{index ( t )} ≡ ( t - {\{ w \}}_{H} ) \cdot {\{ w \}}_{Fs} \qquad Equation 2$$

It is sometimes useful to find the index in one waveform that is equivalent to the index in another waveform:

$${i}_{2} = {\{ {w}_{2} \}}_{index ( {\{ {w}_{1} \}}_{time ( {i}_{1} )} )} .$$

In other words, the index 2 in waveform 2 of an index 1 in waveform 1 is calculated by finding the time of index 1 in waveform 1, and calculating the index 2 in waveform 2 of this time. Using Equation 1 and Equation 2, you can see that this is calculated as:

$${i}_{2} ( ( {\{ {w}_{1} \}}_{H} + \frac{{i}_{1}}{{\{ {w}_{1} \}}_{Fs}} ) - {\{ {w}_{2} \}}_{H} ) \cdot {\{ {w}_{2} \}}_{Fs} \qquad Equation 3$$

When the sample rate of each waveform is identical (e.g., Fs={w₁}_{Fs}={w₂}_{Fs}), then Equation 3 becomes:

i₂=({w₁}_{H}−{w₂}_{H})·FS+i₁

### Equation 4

The operation of finding the index in one waveform into another is performed so often, that it is given another shorthand notation:

$$Function That Converts the Index of a Waveform into Another \\ {i}_{2} = {\{ {w}_{2} \}}_{index ( {\{ {w}_{1} \}}_{time ( {i}_{1} )} )} ≡ {i}_{1} : \{ {w}_{1} \} : \{ {w}_{2} \} \qquad Equation 5$$

$$[ \begin{matrix}U \\ D \\ S\end{matrix} ]$$

is a filter with upsample factor (U), delay samples (D) and startup samples (S). It describes a filter with S−1 filter taps. When the upsample factor is not unity, there is an ambiguity regarding startup samples and delay samples, since it will depend on whether you consider the output or the input. The delay samples and startup samples are referred to the input to resolve this ambiguity. For the remainder of this document, filters whose upsample factor is unity will be described as standard filters. The upsample factor is unity (for standard filters), an integer greater than 1 (for upsamplers) or a number whose reciprocal is an integer greater than 1 (for downsamplers). The startup samples are integer for standard filters and downsamplers, and are numbers such that when they are multiplied by the upsample factor, are integer for upsamplers.

The delay samples are real. Note that the actual delay time through the filter is both a function of the sample rate of an input waveform and the delay samples of the filter and is not an intrinsic property of the filter.

[f] is a filter named f. The upsample factor, delay samples and startup samples of this filter are written as [f]_{U}, [f]_{D} and [f]_{S}, respectively. Sometimes, this filter is written as

$$[ \begin{matrix}{U}_{f} \\ {D}_{f} \\ {S}_{f}\end{matrix} ]$$

Usually, standard filters, upsamplers and downsamplers are processing elements utilized in a processing system. Sometimes, however, a filter can be viewed as an element that simply transforms waveforms, one into another. In this case, it is written as [in→out] where {in} is an input waveform, {out} is an output waveform, and [in→out] is a filter that transforms {in} into {out}.

The linear phase FIR is a symmetric filter and has constant group delay (and therefore constant delay) for all frequencies. For symmetric linear phase FIRs with integer delay, the number of taps will be odd. For the purposes of considering the filters effect on time and points in an input waveform, it can be considered as simply an L tap filter with zeros in all tap locations except for the tap at (L−1)/2, where there is a 1. The filter has L−1 startup samples and a delay of (L−1)/2. The upsample factor is 1.

$$Symmetric linear phase FIR \\ [ F ] = [ \frac{\begin{matrix}1 \\ L - 1\end{matrix}}{\begin{matrix}2 \\ L - 1\end{matrix}} ] \qquad Equation 6$$

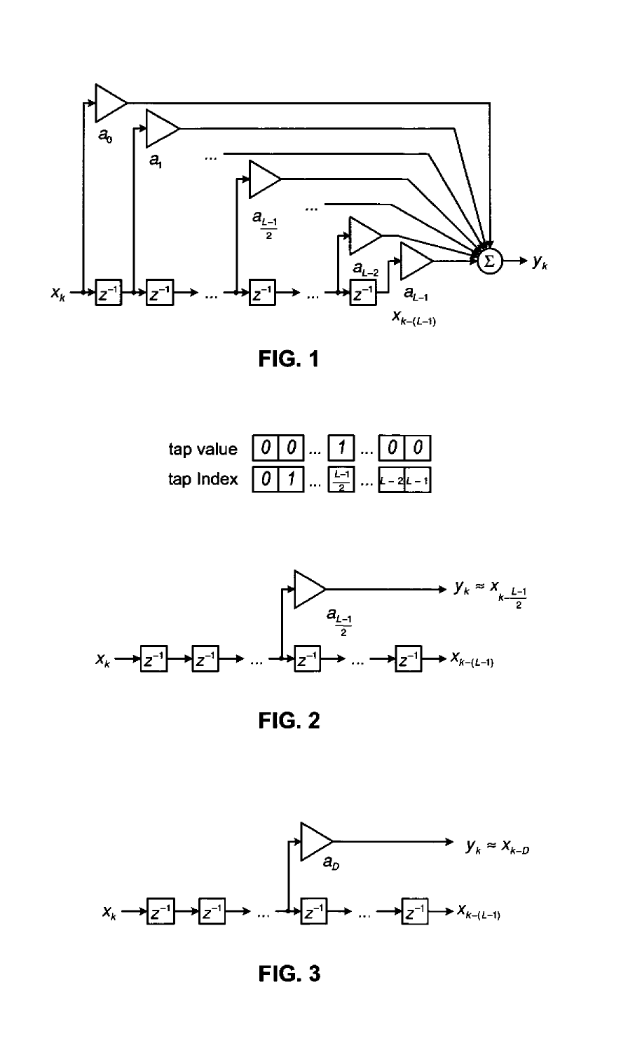

FIG. 1 shows an exemplary finite impulse response (FIR) filter structure. FIG. 2 shows an exemplary integer delay symmetric linear phase FIR filter structure.

The more general case of a linear phase FIR with integer delay is considered here. For an L tap filter with an integer delay of D, it is:

$$General Filter Description for a Linear Phase FIR \\ [ F ] = [ \begin{matrix}1 \\ D \\ L - 1\end{matrix} ] \qquad Equation 7$$

FIG. 3 shows an exemplary integer delay linear phase FIR. Linear phase FIRs with fractional delay are considered as fractional delay elements cascaded with an integer delay FIR:

$$[ F ] = [ \begin{matrix}1 \\ D \\ L - 1\end{matrix} ] = [ \begin{matrix}1 \\ {D}_{fractional} \\ 0\end{matrix} ] \cdot [ \begin{matrix}1 \\ {D}_{integer} \\ L - 1\end{matrix} ]$$

Examples of filter multiplication will be described in further detail in subsequent sections.

A general form is given by:

$$Filter Description for a Linear Phase FIR with Fractional Delay \\ [ F ] = [ \begin{matrix}1 \\ {D}_{integer} + {D}_{fractional} \\ L - 1\end{matrix} ] \qquad Equation 8$$

D_{integer} is the location of the single tap coefficient that can be made unity in the simplified filter view when the impulse response of the filter is shifted by D_{fractional} samples.

In some embodiments, a FIR with non-linear phase may be considered to have more than a single delay value, since the filter delay is a function of frequency. For this exemplary method, the delay value may be considered at a single frequency, or will have to be considered in a region where the delay is essentially constant. Examples of this might be minimum phase low pass, high pass, band-stop or band-pass filters designed by sampling the impulse response of classical IIR filters. For the low-pass cases, typically the zero frequency group delay is utilized. For band-stop cases, zero is often used for the delay since the region to be passed is often unaffected by the filter.

The IIR filter is typically non-linear in phase and group delay. Regarding startup samples, some judgment will also need to be applied since the IIR filter typically has an infinite startup time. Usually, one uses the number of samples for the impulse response to settle to an acceptably low level (like 0.1%).

Upsamplers are usually implemented in concert with a filter. In some examples, upsampler may be considered as an element that pads the input by inserting a number of values (e.g., zeros) between each sample equal to the upsample factor. As used herein, upsampling filter may generally refer to interpolation type filters (e.g., an upsampler cascaded with a low-pass filter).

Upsamplers are sometimes associated with an upsample factor (U). For each input sample, an upsampler produces U output samples consisting of the input sample followed by U−1 output samples that are zeros. In various examples, zero padding comes after the input sample.

Upsamplers have a notion of phase. The phase of an upsampler is defined as the number of the output sample point produced from an input sample point. An upsampler produces U output samples for each input sample. The first point (point 0) is the input sample point itself. The remaining U−1 sample points are zeros. So, the phase of the first output point is zero, the phase of the next output point is one, and the phase of the final output point produced from a given input point is U−1. For the purpose of pseudo-filter definition, an upsampler is:

$$Upsampler \\ [ F ] = [ \begin{matrix}U \\ 0 \\ 0\end{matrix} ] \qquad Equation 9$$

For purposes of illustration, the notion of phase may be considered from the standpoint of a system that pulls data from the output. To understand this, consider what happens when we have an input buffer containing a single input point applied to an upsampler. For this example, consider the fact that the upsampler has an upsample factor of four. We know that the input buffer, therefore, produces four points—the input point followed by four zeros. To take the second point from the output of the upsampler could be the same as applying the point to the upsampler and taking one point with a phase of one. The point is a zero, which is easy enough to determine, but you can imagine that the concept of phase will be more important when operating on buffers containing numerous data points.

An upsampler may, for example, operate on an input buffer assuming that the first output point is taken with an output phase of zero. When operated with a nonzero output phase, it may be considered as an upsampler followed by a filter that trims, or throws away, output points.

Upsampling filters may be implemented in a polyphase arrangement. In this arrangement, each input sample is provided to a number of filter phases equal to the upsample factor and the output of each filter phase is inserted into the output. In this arrangement, each filter can be considered to be a fractional delay filter and the output of each phase is time interleaved to provide the higher sample rate.

Upsampling filters can also be implemented in a single-phase arrangement. In this arrangement, each input enters an upsampler that simply pads the output with extra zeros. It is followed by a (usually low pass) filter to filter out the unwanted frequency images created by the upsampler.

While each implementation may have strengths and weaknesses from a processing effort point of view, they are functionally similar and can be designed such that upsampling filters with either arrangement can produce identical output data.

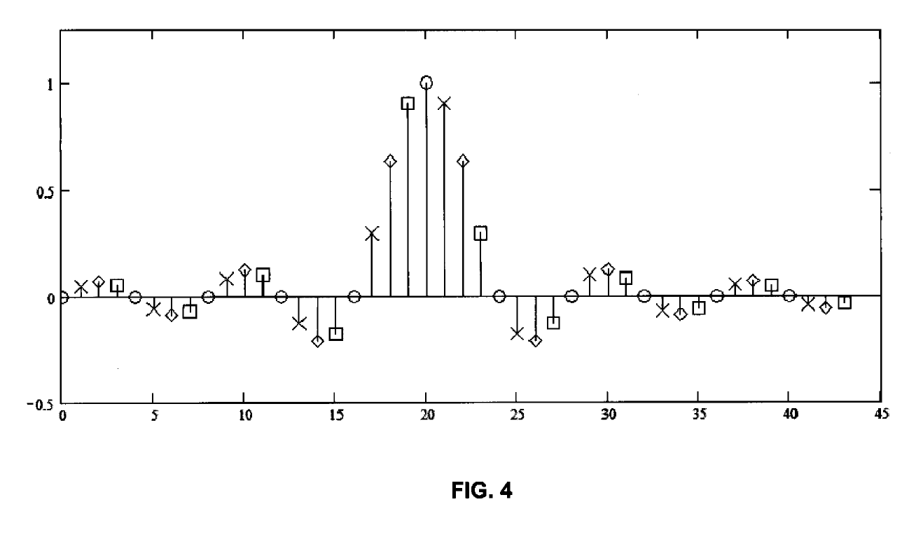

In the polyphase arrangement, each filter phase may, for example, have L filter taps with L odd for symmetry. Since each filter phase is designed for fractional delay, we know that phase zero would have a fractional delay of zero. In other words, it would pass a delayed version of the input only (e.g., the filter coefficients would be zero everywhere except at one point where it would be one). FIG. 4 illustrates this in one embodiment.

FIG. 4 shows exemplary filter coefficients of an upsampling filter with an upsample factor of four. In FIG. 4, the filter coefficients of an upsampling filter with an upsample factor of four are shown. Each filter phase (for a polyphase arrangement) is shown with a different symbol: A circle for phase 0, an X for phase 1, a diamond for phase 2 and a square for phase 3. Filter phase zero may be a filter as described by Equation 6. The output of the polyphase upsampling filter would be the same as passing the input through filter phase zero and then increasing the sample rate of the output. In fact, the equivalent system would be:

$$Upsampling Filter ( Polyphase Arrangement ) \\ [ F ] = [ \frac{\begin{matrix}1 \\ L - 1\end{matrix}}{\begin{matrix}2 \\ L - 1\end{matrix}} ] \cdot [ \begin{matrix}U \\ 0 \\ 0\end{matrix} ] \qquad Equation 10$$

In a single phase arrangement, the input would be upsampled by zero padding and passed through a low-pass filter. FIG. 4 shows the filter coefficients of the typical low-pass filter used, where the filter phases for the polyphase situation are interleaved to form a single-phase filter. Examination of FIG. 4 reveals that the interleaving of the polyphase filters results in an asymmetric filter. To make it symmetric, it is customary to trim U−1 samples from the end making it an L−U+1=(L−1)·U+1 length symmetric filter. Therefore, the upsampling filter can be described as:

$$Upsampling Filter ( Single \text{-} phase Arrangement ) \\ [ F ] = [ \begin{matrix}U \\ 0 \\ 0\end{matrix} ] \cdot [ \frac{\begin{matrix}1 \\ ( L - 1 ) \cdot U\end{matrix}}{\begin{matrix}2 \\ ( L - 1 ) \cdot U\end{matrix}} ] \qquad Equation 11$$

Both filter arrangements of this example may be substantially equivalent:

$$Upsampling Filter \\ [ F ] = [ \frac{\begin{matrix}1 \\ L - 1\end{matrix}}{\begin{matrix}2 \\ L - 1\end{matrix}} ] \cdot [ \begin{matrix}U \\ 0 \\ 0\end{matrix} ] = [ \begin{matrix}U \\ 0 \\ 0\end{matrix} ] \cdot [ \frac{\begin{matrix}1 \\ ( L - 1 ) \cdot U\end{matrix}}{\begin{matrix}2 \\ ( L - 1 ) \cdot U\end{matrix}} ] = [ \frac{\begin{matrix}U \\ L - 1\end{matrix}}{\begin{matrix}2 \\ L - 1\end{matrix}} ] \qquad Equation 12$$

Equation 12 may apply when constructing upsampling filters. First, the upsampler used may pad zeros after the input sample. In other words, when an input sample arrives at the upsampler input, it produces the input sample followed by U zeros. It may also assume that the polyphase filter arrangement contains a filter phase 0 which simply passes the delayed input sample, with all subsequent phases providing increasing fractional delay (when referred to the input).

To summarize the exemplary upsampling filter, when an upsampling filter is constructed in a polyphase arrangement, a general description is given by:

$$General Form of Polyphase Upsampling Filter \\ [ F ] = [ \begin{matrix}1 \\ D \\ L - 1\end{matrix} ] \cdot [ \begin{matrix}U \\ 0 \\ 0\end{matrix} ] = [ \begin{matrix}U \\ D \\ L - 1\end{matrix} ] \qquad Equation 13$$

Where U is the number of filter phases, D is the delay, in samples, of phase 0 of the polyphase filter, and L is the number of filter taps in each phase.

The general description of an upsampling filter constructed in a single-phase arrangement is given by:

$$General Form of Single \text{-} Phase Upsampling Filter \\ [ F ] = [ \begin{matrix}U \\ 0 \\ 0\end{matrix} ] \cdot [ \begin{matrix}1 \\ D \\ L - 1\end{matrix} ] = [ \frac{\begin{matrix}U \\ D\end{matrix}}{\begin{matrix}U \\ \frac{L - 1}{U}\end{matrix}} ] \qquad Equation 14$$

Where U is the upsample factor, D is the delay, in samples of the (usually low-pass) filter following the upsampler, and L is the number of filter taps in that filter.

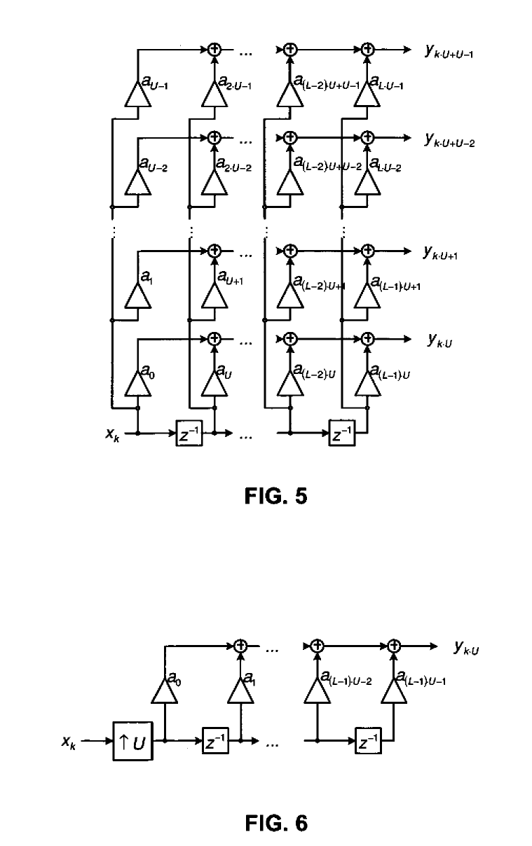

FIG. 5 shows an exemplary polyphase upsampler configuration. FIG. 6 shows an exemplary single-phase upsampler configuration.

Downsamplers may be viewed as decimators that decimate a waveform by an integer decimation factor:

$$Filter Description for an Integer Decimation Factor Downsampler \\ [ f ] = [ \begin{matrix}\frac{1}{DF} \\ 0 \\ 0\end{matrix} ] where DF is the downsampler factor . \qquad Equation 15$$

Note that downsamplers that do not downsample with an integer downsample factor are not considered downsamplers for the purpose of this system. They would be actually a combination of an upsampling filter and a downsampler.

If the goal is to downsample by a factor of DF where DF is a rational number that can be described by DF=d/u, then the processing element would be described as:

$$Filter Description for a Fractional Decimation Factor Downsampler \\ [ f ] = [ \begin{matrix}u \\ 0 \\ 0\end{matrix} ] \cdot [ \begin{matrix}1 \\ D \\ S\end{matrix} ] \cdot [ \begin{matrix}\frac{1}{d} \\ 0 \\ 0\end{matrix} ] = [ \begin{matrix}\frac{u}{d} \\ \frac{D}{u} \\ \frac{S}{u}\end{matrix} ] \qquad Equation 16$$

where

$$[ \begin{matrix}1 \\ D \\ S\end{matrix} ]$$

is the specification of an implied filter utilized with an upsampling filter that would precede the downsampler. This filter may be implemented, for example, as two distinct processing stages—an upsampling filter followed by a downsampler.

In this exemplary system, the delay samples provided may be utilized to keep track of the delay induced by filters. Properly accounted for, filters that have delay provide no actual delay in the final output waveform (e.g., because the delay stated for each filter may be counteracted during the calculation). For example, when an input waveform is passed through a filter with delay specified, and the filter actually provides the delay specified, then when the output waveform is plotted on the same time scale as the input waveform, there will be no delay shown.

In some implementations, it may be desired to intentionally shift a waveform in time such that the input and output waveform would plot with the delay shown. If an input waveform is passed through a filter with no delay specified, but the filter used for processing actually does provide delay, then the output waveform will be shown delayed in time relative to the input waveform. Similarly, if the filter processing element provides no delay, and delay is specified, then the output waveform may be shown advanced in time relative to the input waveform.

Examples relating to delay are illustrated in the following table:

TABLE 1
Various Delay Effects

| When you want to . . . | Then you . . . |
|---|---|
| Properly account for and | Specify the exact amount of delay |
| counteract the effects | provided by the filter in the filter description |
| of filter delay. | |
| Modify the sample | Introduce a fractional delay filtering |
| phase of a waveform | element and properly specify the amount of |
| | fractional delay provided by the filtering |
| | element in the filter description. |
| Physically delay the | Introduce a filter element that provides |
| points in time of a | delay and specify the amount of delay as zero |
| given waveform | in the filter description |
| | OR |
| | Do not do anything physically to the |
| | waveform, but specify the amount of delay as |
| | the negative of the amount of physical delay |
| | desired. |

Various benefits of some embodiments may relate to operators that are defined for calculating the effects that filters have on waveforms. An exemplary operator for this system is the multiplication of a waveform times a filter. In some cases, this may be considered as applying the filter to the waveform.

$$Multiplication of Waveforms and Filters \\ \{ \begin{matrix}H \\ N \\ Fs\end{matrix} \} \cdot [ \begin{matrix}U \\ D \\ S\end{matrix} ] ≡ \{ \begin{matrix}H + \frac{S - D}{Fs} \\ ( N - S ) \cdot U \\ Fs \cdot U\end{matrix} \} \qquad Equation 17$$

{Wᵢₙ}·[F]={Wₒᵤₜ} is read as “{Wₒᵤₜ} is the waveform that results from applying a filter [F] to an input waveform {Wᵢₙ}”.

In general, waveforms may be post-multiplied by filters such that the waveform may be on the left. The result of pre-multiplying a waveform by a filter is not defined. The result of multiplying a waveform times a filter is a waveform.

It may be useful to identify the effects that a filter has on a waveform when applied. One effect may be on the sample rate: it changes by the upsample factor of the filter. Also, the startup samples of the filter may be removed from the input waveform. Note that upsamplers produce additional points and remove additional startup samples in proportion to the upsample factor. The horizontal offset of the waveform may be adjusted due to two effects. In some examples, the removal of the startup samples may cause the horizontal offset to increase since it defines the time of the first point and the startup samples are handled by trimming samples from the front of the waveform. The delay samples causes the horizontal offset to decrease, since delay causes the first point in the waveform to take on an earlier time. The upsample factor may not enter into the effect that the startup samples and delay samples have on the horizontal offset when referred to the input of the filter.

The division of a waveform by a filter is interpreted as applying the inverse of a filter to a waveform. It is equivalent to solving for {Wᵢₙ} in {wᵢₙ}·[F]={Wₒᵤₜ} given {wₒᵤₜ} and [F].

$$\frac{\{ {W}_{out} \}}{[ F ]}$$

is equivalent to asking “what is the input waveform {Wᵢₙ} that, when applied to filter [F], produces the output waveform {Wₒᵤₜ}”.

$$Division of Waveforms by Filters \\ \frac{\{ \begin{matrix}H \\ N \\ Fs\end{matrix} \}}{[ \begin{matrix}U \\ D \\ S\end{matrix} ]} ≡ \{ \begin{matrix}H \\ N \\ Fs\end{matrix} \} \cdot {[ \begin{matrix}U \\ D \\ S\end{matrix} ]}^{- 1} ≡ \{ \begin{matrix}H + \frac{U}{Fs} \cdot ( D - S ) \\ \frac{N}{U} + S \\ \frac{Fs}{U}\end{matrix} \} \qquad Equation 18$$

Note that the input waveform resulting from division of an output waveform by a filter can result in fractional numbers of points. This can happen only if the upsample factor of the filter is greater than unity.

The multiplication of filters is interpreted as cascading them. It is equivalent to asking what the system equivalent is to the two cascaded sections.

$$Filter Multiplication \\ [ \begin{matrix}{U}_{L} \\ \begin{matrix}{D}_{L} \\ {S}_{L}\end{matrix}\end{matrix} ] \cdot [ \begin{matrix}{U}_{R} \\ \begin{matrix}{D}_{R} \\ {S}_{R}\end{matrix}\end{matrix} ] ≡ [ \begin{matrix}{U}_{L} \cdot {U}_{R} \\ \frac{{U}_{L} \cdot {D}_{L} + {D}_{R}}{{U}_{L}} \\ \frac{{U}_{L} \cdot {S}_{L} + {S}_{R}}{{U}_{L}}\end{matrix} ] \qquad Equation 19$$

Note that:

$$[ \begin{matrix}1 \\ {D}_{L} \\ {S}_{L}\end{matrix} ] \cdot [ \begin{matrix}1 \\ {D}_{R} \\ {S}_{R}\end{matrix} ] = [ \begin{matrix}1 \\ {D}_{L} + {D}_{R} \\ {S}_{L} + {S}_{R}\end{matrix} ]$$

or in other words, to cascade standard filters, you may add the delay samples and startup samples.

In standard filters (ones without any rate changes), the order is unimportant, but in general the order of filter multiplication is important and will produce different results when cascaded in a different order.

$$[ a ] \cdot [ b ] = [ b ] \cdot [ a ] if and only {if [ a ]}_{D} \cdot ( 1 - \frac{1}{{[ b ]}_{U}} ) = {[ b ]}_{D} \cdot ( 1 - \frac{1}{{[ a ]}_{U}} ) {and [ a ]}_{S} \cdot ( 1 - \frac{1}{{[ b ]}_{U}} ) = {[ b ]}_{S} \cdot ( 1 - \frac{1}{{[ a ]}_{U}} )$$

For example, the following calculation may be evaluated.

$$[ \begin{matrix}{U}_{a} \\ {D}_{a} \\ {S}_{a}\end{matrix} ] \cdot [ \begin{matrix}{U}_{b} \\ {D}_{b} \\ {S}_{b}\end{matrix} ] = [ \begin{matrix}{U}_{a} \cdot {U}_{b} \\ \frac{{U}_{a} \cdot {D}_{a} + {D}_{b}}{{U}_{a}} \\ \frac{{U}_{a} \cdot {S}_{a} + {S}_{b}}{{U}_{a}}\end{matrix} ] and [ \begin{matrix}{U}_{b} \\ {D}_{b} \\ {S}_{b}\end{matrix} ] \cdot [ \begin{matrix}{U}_{a} \\ {D}_{a} \\ {S}_{a}\end{matrix} ] = [ \begin{matrix}{U}_{b} \cdot {U}_{a} \\ \frac{{U}_{b} \cdot {D}_{b} + {D}_{a}}{{U}_{b}} \\ \frac{{U}_{b} \cdot {S}_{b} + {S}_{a}}{{U}_{b}}\end{matrix} ]$$

The foregoing calculation can yield the following.

$$[ \begin{matrix}{U}_{a} \\ {D}_{a} \\ {S}_{a}\end{matrix} ] \cdot [ \begin{matrix}{U}_{b} \\ \begin{matrix}{D}_{b} \\ {S}_{b}\end{matrix}\end{matrix} ] = [ \begin{matrix}{U}_{b} \\ {D}_{b} \\ {S}_{b}\end{matrix} ] \cdot [ \begin{matrix}{U}_{a} \\ {D}_{a} \\ {S}_{a}\end{matrix} ] if {D}_{a} \cdot ( 1 - \frac{1}{{U}_{b}} ) = {D}_{b} \cdot ( 1 - \frac{1}{{U}_{a}} ) and {S}_{a} \cdot ( 1 - \frac{1}{{U}_{b}} ) = {S}_{b} \cdot ( 1 - \frac{1}{{U}_{a}} )$$

As such, filter multiplication does not generally commute, except under specific conditions. Fortunately, these conditions are generally met in the following circumstances:
1. Uₐ=U_{b}=1—when the filters are standard filters.
2. [a]=[b]⁻¹, [b]=[a]⁻¹—when a filter is the inverse of the other. (e.g., [f]·[f]⁻¹=[f]⁻¹·[f])

Filters may associate.

[a]·([b]·[c])=([a]·[b])·[c]

For example, the following calculation may be evaluated.

$$( [ \begin{matrix}{U}_{a} \\ {D}_{a} \\ {S}_{a}\end{matrix} ] \cdot [ \begin{matrix}{U}_{b} \\ {D}_{b} \\ {S}_{b}\end{matrix} ] ) \cdot [ \begin{matrix}{U}_{c} \\ {D}_{c} \\ {S}_{c}\end{matrix} ] = [ \begin{matrix}{U}_{a} \cdot {U}_{b} \\ \frac{{U}_{a} \cdot {D}_{a} + {D}_{b}}{{U}_{a}} \\ \frac{{U}_{a} \cdot {S}_{a} + {S}_{b}}{{U}_{a}}\end{matrix} ] \cdot [ \begin{matrix}{U}_{c} \\ {D}_{c} \\ {S}_{c}\end{matrix} ] = [ \frac{\begin{matrix}{U}_{a} \cdot {U}_{b} \cdot {U}_{c} \\ {U}_{a} \cdot {U}_{b} \cdot \frac{{U}_{a} \cdot {D}_{a} + {D}_{b}}{{U}_{a}} + {D}_{c}\end{matrix}}{\begin{matrix}{U}_{a} \cdot {U}_{b} \\ \frac{{U}_{a} \cdot {U}_{b} \cdot \frac{{U}_{a} \cdot {S}_{a} + {S}_{b}}{{U}_{a}} + {S}_{c}}{{U}_{a} \cdot {U}_{b}}\end{matrix}} ] and [ \begin{matrix}{U}_{a} \\ {D}_{a} \\ {S}_{a}\end{matrix} ] \cdot ( [ \begin{matrix}{U}_{b} \\ {D}_{b} \\ {S}_{b}\end{matrix} ] \cdot [ \begin{matrix}{U}_{c} \\ \begin{matrix}{D}_{c} \\ {S}_{c}\end{matrix}\end{matrix} ] ) = [ \begin{matrix}{U}_{a} \\ {D}_{a} \\ {S}_{a}\end{matrix} ] \cdot [ \begin{matrix}\begin{matrix}{U}_{b} \cdot {U}_{c} \\ \frac{{U}_{b} \cdot {D}_{b} + {D}_{c}}{{U}_{b}}\end{matrix} \\ \frac{{U}_{b} \cdot {S}_{b} + {S}_{c}}{{U}_{b}}\end{matrix} ] = [ \begin{matrix}{U}_{a} \cdot {U}_{b} \cdot {U}_{c} \\ \frac{{U}_{a} \cdot {D}_{a} + \frac{{U}_{b} \cdot {D}_{b} + {D}_{c}}{{U}_{b}}}{{U}_{a}} \\ \frac{{U}_{a} \cdot {S}_{a} + \frac{{U}_{b} \cdot {S}_{b} + {S}_{c}}{{U}_{b}}}{{U}_{a}}\end{matrix} ]$$

The foregoing calculation can yield the following.

$$( [ \begin{matrix}{U}_{a} \\ {D}_{a} \\ {S}_{a}\end{matrix} ] \cdot [ \begin{matrix}{U}_{b} \\ {D}_{b} \\ {S}_{b}\end{matrix} ] ) \cdot [ \begin{matrix}{U}_{c} \\ {D}_{c} \\ {S}_{c}\end{matrix} ] = [ \begin{matrix}{U}_{a} \\ \begin{matrix}{D}_{a} \\ {S}_{a}\end{matrix}\end{matrix} ] \cdot ( [ \begin{matrix}{U}_{b} \\ \begin{matrix}{D}_{b} \\ {S}_{b}\end{matrix}\end{matrix} ] \cdot [ \begin{matrix}{U}_{c} \\ {D}_{c} \\ {S}_{c}\end{matrix} ] ) if$$

$$\frac{{U}_{a} \cdot {U}_{b} \cdot \frac{{U}_{a} \cdot {D}_{a} + {D}_{b}}{{U}_{a}} + {D}_{c}}{{U}_{a} \cdot {U}_{b}} = \frac{{U}_{a} \cdot {D}_{a} + \frac{{U}_{b} \cdot {D}_{b} + {D}_{c}}{{U}_{b}}}{{U}_{a}} and$$

$$\frac{{U}_{a} \cdot {U}_{b} \cdot \frac{{U}_{a} \cdot {S}_{a} + {S}_{b}}{{U}_{a}} + {S}_{c}}{{U}_{a} \cdot {U}_{b}} = \frac{{U}_{a} \cdot {S}_{a} + \frac{{U}_{b} \cdot {S}_{b} + {S}_{c}}{{U}_{b}}}{{U}_{a}}$$

Algebraic manipulation of both equations shows that both sides of both equations are equal and the associative property applies.

The division of a waveform by another is interpreted as determining the filter between them. It is equivalent to solving for [F] in {Wᵢₙ}·[F]={Wₒᵤₜ} given {Wᵢₙ} and {Wₒᵤₜ}.

$$\frac{\{ {W}_{out} \}}{\{ {W}_{i n} \}}$$

is equivalent to asking “What is the filter [F], that when applied to waveform {Wᵢₙ}, produces the output waveform {Wₒᵤₜ}”.

$$Waveform Division \\ \frac{\{ \begin{matrix}{H}_{o} \\ {N}_{o} \\ {Fs}_{o}\end{matrix} \}}{\{ \begin{matrix}{H}_{i} \\ {N}_{i} \\ {Fs}_{i}\end{matrix} \}} ≡ [ \begin{matrix}\frac{{Fs}_{o}}{{Fs}_{i}} \\ {N}_{i} - \frac{{N}_{o}}{\frac{{Fs}_{o}}{{Fs}_{i}}} - ( {H}_{o} - {H}_{i} ) \cdot {Fs}_{i} \\ {N}_{i} - \frac{{N}_{o}}{\frac{{Fs}_{o}}{{Fs}_{i}}}\end{matrix} ] \qquad Equation 20$$

Since {Wᵢₙ}·[F]={Wₒᵤₜ}, [F]={Wₒᵤₜ}/{Wᵢₙ} may be described with another shorthand notation as [Wᵢₙ→Wₒᵤₜ]:

$$Waveform Transformation Filter \\ [ {W}_{i n} \to {W}_{out} ] ≡ \frac{\{ {W}_{out} \}}{\{ {W}_{i n} \}} \qquad Equation 21$$

This is read as the filter that transforms Wᵢₙ into Wₒᵤₜ.

Since {Wᵢₙ}·[F]={Wₒᵤₜ}, then {Wₒᵤₜ}·[F]⁻¹={Wᵢₙ}. As such, {Wᵢₙ}·[F]·[F]⁻¹={Wᵢₙ} and [F]·[F]⁻¹=[I] where [I] is the identity filter. The identity filter is a filter that has no effect on the input waveform:

$$Identity Filter \\ [ l ] ≡ [ \begin{matrix}1 \\ 0 \\ 0\end{matrix} ] . \qquad Equation 22$$

The filter inverse [F]⁻¹ is the filter that solves [F]·[F]⁻¹=[l] for a given [F].

$$Inverse Filter \\ \frac{1}{[ \begin{matrix}U \\ D \\ S\end{matrix} ]} ≡ {[ \begin{matrix}U \\ D \\ S\end{matrix} ]}^{- 1} ≡ [ \begin{matrix}\frac{1}{U} \\ - D \cdot U \\ - S \cdot U\end{matrix} ] \qquad Equation 23$$

It can be seen that:

$$[ \begin{matrix}U \\ D \\ S\end{matrix} ] \cdot [ \begin{matrix}\frac{1}{U} \\ - D \cdot U \\ - S \cdot U\end{matrix} ] = [ \begin{matrix}U \cdot \frac{1}{U} \\ \frac{U \cdot D - D \cdot U}{U} \\ \frac{U \cdot S - S \cdot U}{U}\end{matrix} ] = [ \begin{matrix}1 \\ 0 \\ 0\end{matrix} ] = [ l ] and \\ [ \begin{matrix}\frac{1}{U} \\ - D \cdot U \\ - S \cdot U\end{matrix} ] \cdot [ \begin{matrix}U \\ D \\ S\end{matrix} ] = [ \begin{matrix}\frac{1}{U} \cdot U \\ \frac{- D + D}{\frac{1}{U}} \\ \frac{- S + S}{\frac{1}{U}}\end{matrix} ] = [ \begin{matrix}1 \\ 0 \\ 0\end{matrix} ] = [ l ]$$

Although the order of filter cascading is generally significant (e.g., the commutative property does not generally apply), the order of operation of a filter and its inverse may not be significant in certain respects:

[F]·[F]⁻¹=[F]⁻¹·[F]=[l]

### Equation 24

### Commutative Property of Filter and Filter Inverse Multiplication

A null waveform is a waveform with no points:

$$Null Waveform \\ \{ null \} ≡ \{ \begin{matrix}x \\ 0 \\ x\end{matrix} \} equals the null waveform ( where x means don ' t care ) . \qquad Equation 25$$

A “clean” null waveform is given by

$$\{ \begin{matrix}0 \\ 0 \\ 0\end{matrix} \} .$$

The test for a null waveform therefore is identical to a test for 0 points:

{w}={null} if {w}hd N=0

In general, filters are used to modify the waveform points. Sometimes, however, they are viewed only as processing elements that trim points from the sides of a waveform. These trimming filters are not necessarily implemented in practice, but they may be used mathematically to determine buffer adaptors and to figure indexes into waveforms.

In general, filters may trim points from the left and right of input waveforms. The number of points trimmed may be a function of the startup samples and the delay samples that are properties of the filter.

$$\begin{matrix}Input Points Trimmed Left by a {Filter \\ [ \begin{matrix}1 \\ D \\ S\end{matrix} ]}_{TL} = S - D & Equation 26 \\ Input Points Trimmed Right by a {Filter \\ [ \begin{matrix}1 \\ D \\ S\end{matrix} ]}_{TR} = D & Equation 27 \\ Total Points Trimmed by a {Filter \\ [ \begin{matrix}1 \\ D \\ S\end{matrix} ]}_{TT} = S & Equation 28\end{matrix}$$

As you can see, the points trimmed from the right of a waveform by a filter are exactly equal to the number of delay samples. In other words: [F]_{TR}=[F]_{D} and [F]_{TR} is only a convenient notation to specifically indicate the points trimmed from the right (without having to remember that this is the same as the delay samples).

Similarly, the total points removed from a waveform are identical to the filter startup samples. In other words [F]_{TT}=[F]_{S} and [F]_{TT} is only a convenient notation to specifically indicate the total number of points removed (without having to remember that this is the same as the startup samples).

The points trimmed from the left are a different situation and [F]_{TL} is a notation indicating this without having to explicitly show the calculation based on startup samples and delay samples.

Another convenient notation is the explicit statement of a filter as a trimmer. Regarding only the effect of points trimmed by a filter, there is a Trimmer/Filter Duality expressed as:

$$\begin{matrix}〈 TL \vert TR 〉 = [ \begin{matrix}1 \\ TR \\ TL + TR\end{matrix} ] is equivalent to [ \begin{matrix}1 \\ D \\ S\end{matrix} ] \\ = 〈 S - D \vert D 〉\end{matrix} \\ Trimmer / Filter Duality \qquad Equation 29$$

[symbol] TL|TR [symbol] is therefore a filter that makes no change to the sample rate, and trims TL points from the left of a waveform and TR points from the right of a waveform.

If a filter only operates to trim points, then it can be utilized to determine waveform segments to pass to the output and, as such, does not modify the waveform data contents. For example, for a given waveform {wᵢₙ} applied to a trimmer [f]= [symbol] TL|TR [symbol] , the output waveform may be calculated by taking a number of points equal to {wᵢₙ}_{N}−[f]_{TT} starting at index {wᵢₙ}_{TL} in the input waveform.

It may be necessary to determine the proper filtering effect when a filter is moved before or after another filter element. Note that this does not imply that order of filtering can be simply interchanged in normal processing operation. It may be useful, however, for determining filters for waveform segment extraction or for adapting buffers.

Filters do not necessarily commute, so a general operator may be used to swap filter order. To determine the effect of swapping filter order, we may define three filters: L (Left), R (Right) and F (Filter) as:

$$[ L ] = [ \begin{matrix}{U}_{L} \\ {D}_{L} \\ {S}_{L}\end{matrix} ] , [ R ] = [ \begin{matrix}{U}_{R} \\ {D}_{R} \\ {S}_{R}\end{matrix} ] , [ F ] = [ \begin{matrix}{U}_{F} \\ {D}_{F} \\ {S}_{F}\end{matrix} ]$$

Then the following equation may be solved: [L]·[F]=[F]·[R] This equation suggests that there is some left filter that, when placed before a filter, is equivalent to some right filter placed after a filter. The binary Before operator is defined as follows:

$$[ L ] = [ R ] Before [ F ] = [ \begin{matrix}{U}_{R} \\ \frac{{U}_{F} \cdot {D}_{F} + {D}_{R}}{{U}_{F}} - \frac{{D}_{F}}{{U}_{R}} \\ \frac{{U}_{F} \cdot {S}_{F} + {S}_{R}}{{U}_{F}} - \frac{{S}_{F}}{{U}_{R}}\end{matrix} ] \\ Filter Before Operator \qquad Equation 30$$

It may be read as: The left filter equals a right filter placed before a filter.

Similarly, the binary After operator is defined as follows:

$$[ R ] = [ L ] After [ F ] = [ \begin{matrix}{U}_{L} \\ ( {U}_{L} \cdot {D}_{L} + {D}_{F} ) \cdot \frac{{U}_{F}}{{U}_{L}} - {U}_{F} \cdot {D}_{F} \\ ( {U}_{L} \cdot {S}_{L} + {S}_{F} ) \cdot \frac{{U}_{F}}{{U}_{L}} - {U}_{F} \cdot {S}_{F}\end{matrix} ] \\ Filter After Operator \qquad Equation 31$$

It may be read as: The right filter equals a left filter placed after a filter.

This may apply, for example, when any filter upsample factor is not unity. For example, if [F]_{U}=1, [L]_{U}=1 and [R]_{U}=1 then: [L]=[R] Before [F]=[R] and [R]32 [L] After [F]=[L] or in other words, [L]=[R]. This suggests that, for some embodiments that employ standard filters, the filter order may be without substantial impact. For example, the order of filtering may not impact processing (e.g., the order of filtering a waveform with unity upsample factor is of substantially no impact even with regard to the processed waveform result).

The unary˜operator removes the startup samples from a filter. This is useful for calculating the output buffer that may hold an output waveform that has been filtered prior to the removal of the startup samples. In other words, usually, an input waveform is filtered into an output buffer without regard to startup samples. Then, an index into this output buffer is formed to get access to the usable points in the output waveform.

$$\sim [ \begin{matrix}U \\ D \\ S\end{matrix} ] ≡ [ \begin{matrix}U \\ D \\ 0\end{matrix} ] \\ Filter Startup Sample Removal \qquad Equation 32$$

As an example: {Sᵢₙ}·[F]={Sₒᵤₜ} is the identity that forms the desired output segment due to filtering an input segment. In this example, {Sᵢₙ}˜[F]={Bₒᵤₜ} may identify the output buffer that is needed to hold the result of the filtering operation.

$$[ {B}_{i n} -> {S}_{i n} ] ≡ \frac{\{ {S}_{i n} \}}{\{ {B}_{i n} \}}$$

is the filter that extracts the desired output segment from the output buffer by removing the startup samples. [Bᵢₙ→Sᵢₙ]_{TL} is the index into the output buffer and {Sₒᵤₜ}_{N} is the number of usable points in the output buffer.

It may often be useful to view waveforms as sets of points. In these cases, it is useful to define set operations:

The intersection of two waveforms consists of the points that appear in the time spans occupied by both waveforms and is generally thought of as the overlapping portion of two waveforms.

$$\begin{matrix}\{ {w}_{1} \} ⋂ \{ {w}_{2} \} = \{ \begin{matrix}{H}_{1} \\ {N}_{1} \\ Fs\end{matrix} \} ⋂ \{ \begin{matrix}{H}_{2} \\ {N}_{2} \\ Fs\end{matrix} \} ≡ \{ \begin{matrix}max ( {\{ {w}_{1} \}}_{H} , {\{ {w}_{1} \}}_{H} ) \\ max ( 0 , ( min ( {\{ {w}_{1} \}}_{time ( {N}_{1} )} , {\{ {w}_{2} \}}_{time ( {N}_{2} )} ) - max ( {\{ {w}_{1} \}}_{H} , {\{ {w}_{1} \}}_{H} ) ) \cdot {\{ {w}_{1} \}}_{Fs} ) \\ {\{ {w}_{1} \}}_{Fs}\end{matrix} \} \\ Waveform Intersection \\ or & Equation 33 \\ \{ {w}_{1} \} ⋂ \{ {w}_{2} \} = \{ \begin{matrix}{H}_{1} \\ {N}_{1} \\ Fs\end{matrix} \} ⋂ \{ \begin{matrix}{H}_{2} \\ {N}_{2} \\ Fs\end{matrix} \} ≡ \{ \begin{matrix}max ( {\{ {w}_{1} \}}_{H} , {\{ {w}_{2} \}}_{H} ) \\ max ( 0 , min ( \begin{matrix}{\{ {w}_{2} \}}_{N} - 1 \text{:} \{ {w}_{2} \} \text{:} \{ {w}_{1} \} - 0 \text{:} \{ {w}_{2} \} \text{:} \{ {w}_{1} \} , \\ {\{ {w}_{1} \}}_{N} - 1 \text{:} \{ {w}_{1} \} \text{:} \{ {w}_{2} \} - 0 \text{:} \{ {w}_{1} \} \text{:} \{ {w}_{2} \}\end{matrix} ) ) \\ {\{ {w}_{1} \}}_{Fs}\end{matrix} \} \\ Alternate Waveform Intersection & Equation 34\end{matrix}$$

Note that the intersection assumes the sample rate of the left hand waveform.

Note also that the number of points in the intersection waveform may be fractional, if sample points in each of the two waveforms are not sampled simultaneously. In utilizing the Intersection of two waveforms, it is usual to use floor (({W₁}∩{W₂})_{N}) as the actual number of points in the overlapping waveform. If the waveform does not overlap, the number of points in the calculation would come up negative and be clipped to zero and the result is the null waveform.

It may be desired to determine if a waveform is contained within another. This is determined easily by checking that the index of the first and last point of a waveform each convert to an index in the second waveform that is not negative and is less than the number of points (minus one) in the second waveform:

{w₁}⊂{w₂}=(0≦0:{w₁}:{w₂}≦{w₂}_{N}−1)̂(0≦{w₁}_{N}−1:{w₁}:{w₂}≦{w₂}_{N}−1).

### Equation 35

### Waveform Subset

A waveform is defined as a proper subset of another if it is a subset of another and it is not equal to the other:

{w₁}⊂{w₂}=({w₁}⊂{w₂})̂({w₁}≠{w₂}).

### Equation 36

### Waveform Proper Subset

The union of two waveforms consists of the points that appear in the time spans occupied by either waveform and is considered the waveform that is formed by joining two waveforms together.

$$\begin{matrix}\{ {w}_{1} \} ⋃ \{ {w}_{2} \} = \{ \begin{matrix}{H}_{1} \\ {N}_{1} \\ Fs\end{matrix} \} ⋃ \{ \begin{matrix}{H}_{2} \\ {N}_{2} \\ Fs\end{matrix} \} \\ ≡ \{ \begin{matrix}max ( {\{ {w}_{1} \}}_{H} , {\{ {w}_{1} \}}_{H} ) \\ ( max ( {\{ {w}_{1} \}}_{time ( {N}_{1} - 1 )} , {\{ {w}_{2} \}}_{time ( {N}_{2} - 1 )} ) - min ( {\{ {w}_{1} \}}_{H} , {\{ {w}_{1} \}}_{H} ) ) \cdot {\{ {w}_{1} \}}_{Fs} \\ {\{ {w}_{1} \}}_{Fs}\end{matrix} \}\end{matrix} Waveform Union \qquad Equation 37$$

If there is a gap between the waveforms (e.g., the waveforms are not overlapping and are not contiguous), then the union can be deceiving because the gap is added to the union as if the points are actually covered. There is a simple test for this case.

Two waveforms may be considered contiguous, for example, if they are sampled substantially with the same sample phase and the first point beyond the limit of one waveform is the first point of the other waveform. For example:

{w₁} and {w₂} are contiguous if:

$$( {\{ {w}_{1} \}}_{N} \text{:} \{ {w}_{1} \} \text{:} \{ {w}_{2} \} = 0 ) ⋁ ( {\{ {w}_{2} \}}_{N} \text{:} \{ {w}_{2} \} \text{:} \{ {w}_{1} \} = 0 ) \\ or \text{:} \\ ( {\{ {w}_{1} \}}_{time ( {\{ {w}_{1} \}}_{N} )} = {\{ {w}_{2} \}}_{H} ) ⋁ ( {\{ {w}_{2} \}}_{time ( {\{ {w}_{2} \}}_{N} )} = {\{ {w}_{1} \}}_{H} ) \\ Waveform Contiguousness Test \qquad Equation 38$$

Two waveforms may be considered to be overlapping if the number of points in their intersection is nonzero:

{w₁} and {w₂} are overlapping if:

({W₁}∩{W₂})≠{null}

### Equation 39

### Waveform Overlap Test

Often, when processing two waveforms together (like summing them, etc.) it may be desired to have both waveforms sampled at the same sample phase. This means that if you were to make an infinite array of times from extending to infinity on both positive and negative time where each time point is separated from the previous by the reciprocal of the sample rate and one of the time points is the horizontal offset, then both waveforms time points would appear in this array somewhere. This reduces to a test that the horizontal offset of each waveform is separated by a time that is an integer multiple of the sample period.

{w₁} and {w₂} are sampled in the same sample phase if the sample rates are substantially identical:

{w₁}_{Fs}={w₂}_{Fs}=Fs

and:

({w₁}_{H}−{w₂}_{H})·FS is integer

or alternatively if:

0:{w₁}:{w₂} is integer

### Equation 40

### Same Waveform Sample Phase Test

In various examples, pseudo-waveforms and pseudo-filters may be used in waveform processing. For example, systems may contain cascaded processing elements.

Illustrative examples may be described with reference to the context of waveform processing within an oscilloscope. During operation, the oscilloscope may typically be calibrated and armed for acquisition. The arming of the oscilloscope typically involves setting various parameters such as vertical gain, sample-rate, length of acquisition, etc. along with a trigger condition. When the oscilloscope is armed, it typically acquires data into a circular memory buffer until the trigger condition is met. When the trigger event occurs, the acquisition eventually stops and the scope is left with a number of digital samples in memory. Usually, a large amount of calculation is required to determine exactly what is sitting in acquisition memory and the result of the calculation is a waveform descriptor. The waveform descriptor is, as the name implies, a description of the data points in memory. The descriptor, along with the actual data points, forms a waveform. During operation, several such waveforms are often acquired on multiple oscilloscope channels. These waveforms are then ready for processing.

The processing of waveforms is performed by waveform processors. In various embodiments, processors may be designed as one or more cascaded filter elements. Processors may, for example, take one or more waveforms as inputs and produce one or more output waveforms.

During the design of the processor, which may be performed dynamically within the scope, the pseudo-filter definitions for each filter element are kept track of following the methods outlined previously. For a number K of filter elements, the equivalent filter system is calculated as:

$$[ {f}_{equivalent} ] = {\prod }_{k} [ {f}_{k} ] where k ∈ 0 … K - 1 \\ Calculation of Equivalent Filter \qquad Equation 41$$

As long as the pseudo-filters accurately describe the effects on time and points of the actual filter elements, then the equivalent filter calculated in this manner accurately reflects the effect of the cascaded filter elements.

Then, to calculate the output waveform {wₒᵤₜ} due to an input waveform {wᵢₙ}, it is simply calculated as:

{wₒᵤₜ}={wᵢₙ}·[f_{equivalent}]

### Equation 42

### Calculation of Output Waveform due to Input Waveform

The output waveform may be calculated as if the entire waveform were to be presented to the processing system and all input data points were processed to produce as many output data points as possible. As we shall see, the actual processing of the output waveform need not be performed in this manner.

In multi-rate systems, it may be desired to take the output waveform as an estimate of the actual output waveform. This is because multi-rate systems may cause intermediate waveforms within the processing chain to contain fractional numbers of points. This estimate is, however, useful in determining how to synchronize multiple waveforms that may be processed together. To illustrate this, consider two processing chains that come together in a summing element. At the summing element, the waveforms may be sampled in the same sample phase. The output waveforms calculated through this simple method provides enough information to determine any fractional delay requirements for a resampler in the chain. Once the fractional delay has been calculated and applied to a resampler in one or both chains, the fractional data points may be handled to determine the waveforms that actually arrive at the summer.

In multi-rate systems where fractional points arise, they may be rounded to the next (e.g., lower) integer number of points before proceeding to the next stage. An exemplary general purpose algorithm is described recursively that allows proper calculation in this situation:

$$\begin{matrix}\{ {w}_{{out}_{0}} \} = \{ {w}_{i n} \} \cdot [ {f}_{0} ] \\ {\{ {w}_{{out}_{0}} \}}_{N} = floor ( {\{ {w}_{{out}_{0}} \}}_{N} + 0.5 ) \\ \begin{matrix}for k = 0 … K - 1 \\ \begin{matrix}\{ {w}_{{out}_{k}} \} = \{ {w}_{{out}_{k - 1}} \} \cdot [ {f}_{k} ] \\ {\{ {w}_{{out}_{k}} \}}_{N} = floor ( {\{ {w}_{{out}_{0}} \}}_{N} + 0.5 )\end{matrix}\end{matrix} \\ \{ {w}_{out} \} = \{ {w}_{{out}_{k - 1}} \}\end{matrix} \\ \begin{matrix}General Purpose Algorithm \\ for calculating Output Waveform\end{matrix} \qquad Equation 43$$

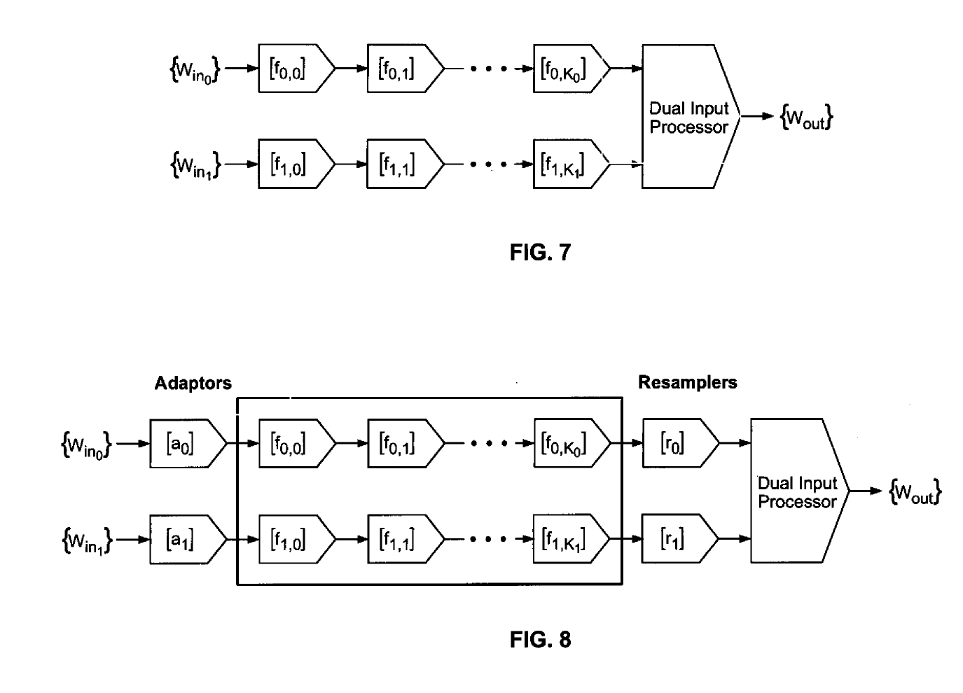

FIG. 7 shows a block diagram for an exemplary waveform synchronization process. The depicted example includes a system with two input waveforms, each with its own processing chain leading to a dual input processing element that may process the waveforms together. This processor might be a multiplier or summer in its simplest form or an interleaver or other more complicated elements.

In the example of FIG. 7, there is a sample phase requirement on the waveforms that are processed together. Generally, the requirement is that each waveform has identical sample phases. In some examples, this may mean that there are points in both waveforms that represent samples that occur at the same time. There may also be size requirements on the waveforms that are processed together. Generally, the specification is that each waveform be the same size. In some cases, if points are processed together, output points may be produced from input waveforms that contain all points sampled at substantially the same time.

FIG. 8 addresses this with two elements to the filter chain. In particular, FIG. 8 shows a block diagram for an exemplary waveform synchronization process with adaptors and resamplers. As used in this example, an adaptor is an element that merely trims integer numbers of points from a waveform. It can be viewed as a filter element consisting of a delay line with one point tapped somewhere in the line to provide the output point. In essence, it provides integer delay and integer startup samples. A resampler is a waveform interpolation element. In essence, it is generally implemented as an upsampling filter with unity upsample factor. In this case, it is introduced to provide fractional delay. In general, only one resampler and one adaptor may be used.

The placement of adaptors and resamplers may be arbitrary. In some examples, system computational effort may be reduced by placing the adaptor as close to the front of the system as possible and placing the resampler as close to the end of the system as possible. One or more adaptors and/or resamplers may be located in a sequence of processing operations, for example.

In an example, an adaptor may placed at the front of the system is not actually implemented as a filter element during waveform processing. In practice, the pseudo-filter representing the adaptor may provide a new index into the input waveform for input waveform buffer requests.

In some examples, the resampler may be placed at or near the end of the system where the sample rate required for the dual processing is known to be the required sample rate. At this location, it may take up fractional delay and startup samples that are not addressed by the adaptor. If the processing chain includes an upsampler, the resampler may optionally be foregone and any required fractional delay may be added to the upsampler.

Since waveform sizes and sample phases can change from acquisition to acquisition within an oscilloscope, the adaptors and resamplers may be computed dynamically to react to changing input waveform characteristics.

Exemplary methods for calculating the resampler and adaptor requirements may be used in various embodiments.

Referring to the example depicted in FIG. 7 and the two input waveforms {wᵢₙ_{ₒ}} and {wᵢₙ_{₁}}, the output waveforms from each processing chain that appears at the input to the dual input processor is calculated utilizing Equation 42 or Equation 43. The intersection of these two waveforms can be considered as the desired waveform as the output of each processing chain. This desired waveform is then divided by each waveform output from each processing chain to determine the filter between the actual processing chain output and the desired waveform. The delay samples of this filter are next considered. Typically, the delay samples of one filter will be fractional and the other will be integer. Calculate the fractional delay for the chain requiring fractional delay and apply a resampler to that chain with the fractional delay, which may involve additional delay and startup samples. Then, recalculate the output waveforms from each processing chain with the introduction of the resampler. The intersection of these waveforms will be the new desired waveform as the output of each processing chain. In a one-to-one dual processing element, for example, it may also describe the output waveform from the dual input waveform processor.

Division of the desired waveform by the output waveforms may provide the desired filter between the output waveforms and the desired output waveform. This may define a filter that adapts the output of the processing chain to the desired input to the dual processor. As mentioned previously, we do not usually want to implement this filter, so we move it to the front of the system utilizing the before operator. The adaptor calculated for implementation at the front of the system may be adjusted to ensure that it provides only integer trimming of points from the input waveform. To do this, calculate the equivalent trimmer for this filter, adjust the points trimmed left and right to the lowest integer trimming. If this integer trimming alters the adaptor filter calculated, the fractional delay or startup samples may be moved to the end of the system using the after operator—it can be integer at that point and might require a filter element with a few samples of delay or startup.

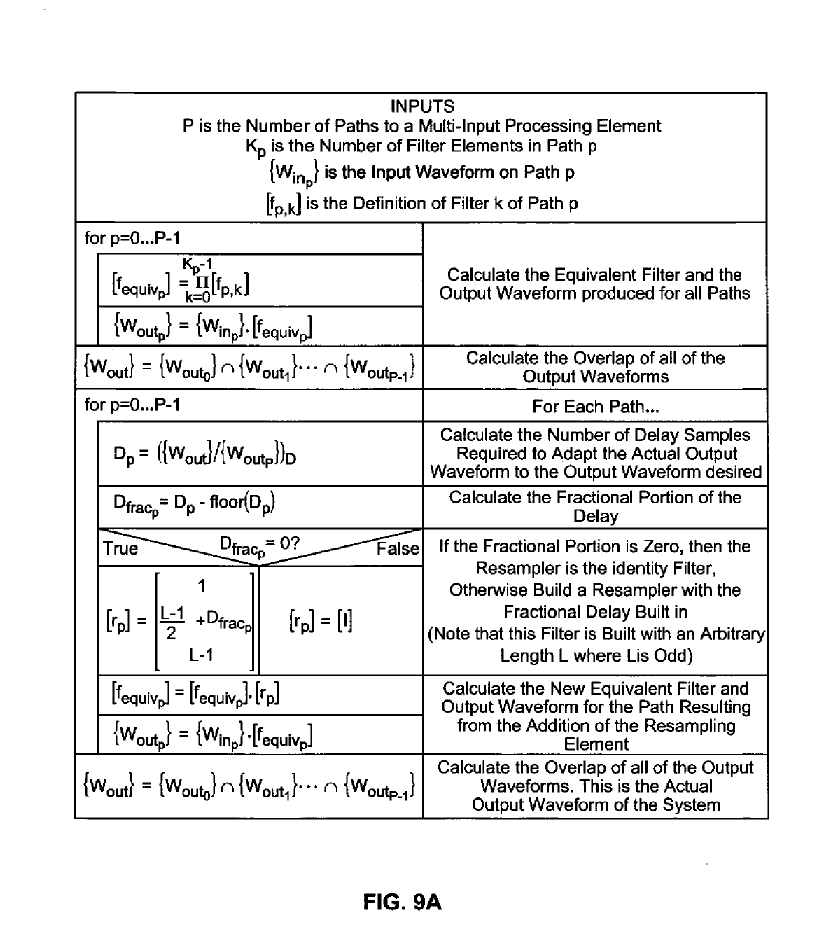

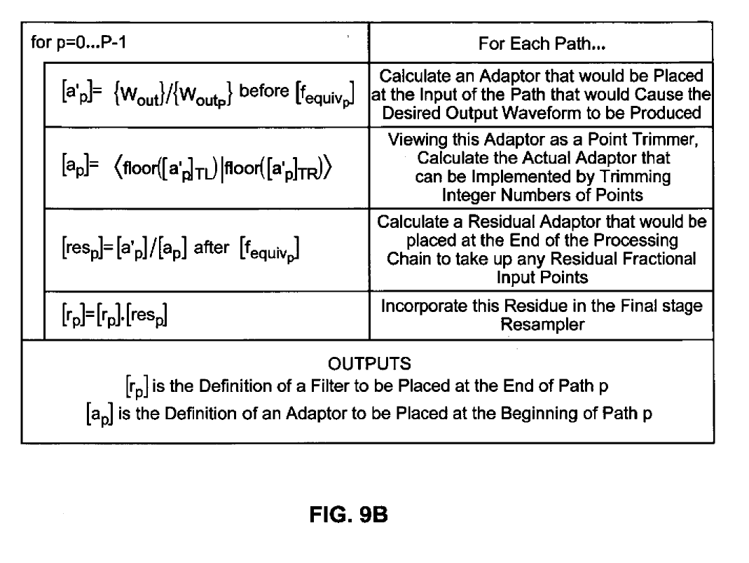

FIG. 9 shows an exemplary algorithm for calculating waveform synchronizing resamplers and adaptors. The depicted example shows the algorithm for computing the filter requirements for the resamplers and adaptors for synchronizing the waveforms. The adaptor may be optional. It may be utilized to calculate the number of points and an index into the input waveform: [aₚ]_{TL} is the index and {wᵢₙ_{ₚ}}_{N}−[aₚ]_{TT} is the total number of points.

In some examples, a system may calculate intermediate buffer segments for processing waveforms in segments. For example, a method may include calculating the intermediate buffer segments and processing requirements when segments of the output waveform are specified.

The above sections dealt with the determination of the output waveform in systems of cascaded elements and the determination of waveform synchronization elements. In both cases, after the implementation of the recommended steps, the output waveform may be known.

Various embodiments may advantageously make efficient use of a cache by taking points in segments from the output. What is provided in this section is a method for making the appropriate calculations for calculating output waveform segments.

After the output waveform is known, a client that is taking points from the output of the processor requests points from the output waveform by specifying the output start index and the output number of points. The first step in is to convert this into an output waveform segment. Then, we walk backwards from the end of the processing chain to the input making calculations of filtering requirements for all processing elements in the chain. For a given filter in the processing chain, the input segment that produces the output segment is calculating by dividing the filter into the output waveform segment. The output buffer required to hold the result of passing the input segment through the filter is calculated by multiplying the input segment by the filter with the startup samples removed. This is an important point. At this point in the discussion, methods for improving the efficiency of the filtering have not yet been outlined, so one may assume that the output segment requested is an isolated segment. In other words, one may assume that no other filter points have been calculated. Because of this assumption, filter startup enters into the equation. To illustrate this point simply, consider a request for one point from the output of an FIR filter of length L. L input points are needed just to calculate this one point. So L points would be taken from the input waveform into an input buffer, filter all L points into an output buffer, and keep the last point.

With the input waveform segment calculated, various embodiments may calculate a filter for extracting the input segment from the input waveform by dividing the input waveform segment by the input waveform. This filter can be viewed as a point trimmer with the sole object of calculating an index into the input waveform to the input segment and for calculating the number of points required from the input waveform. Usually, this is straightforward and the resulting filter defines an integer number of points from an integer start index, but in the case of an upsampler, fractional indexes and numbers of points can occur. To resolve this, some embodiments may limit the point trimmer to removing integer numbers of points from the input waveform and multiply the input waveform by this result to form the actual filter input buffer that will be used. Because of the limitation of integer point trimming, the filter input buffer and the input waveform segment can differ in description. To resolve this, another filter for adapting the input waveform segment to the filter input buffer may be determined, for example, by dividing the input waveform segment by the filter input buffer. This filter either will be the identity filter, or will contain some fractional delay and startup as a result of an upsample factor that is greater than unity. To actually use this filter, it may be moved the output of the filter element using the after operator.

In this example, we determined how to address fractional numbers of points from fractional indexes into the input waveform by calculating a filter input buffer that is created by integer numbers of points from an integer index into the input waveform, allowing this filter buffer to differ from the input waveform segment requested, processing this filter buffer through the filter, and then worrying about trimming points from this output buffer after filtering. In practice, this is optional, as other methods may be used. The filter that adapts the filter output may be used to generate the output sample phase, and this phase is utilized in the processing of the filter input buffer to produce the filter output buffer. Only the number of points previously calculated as the size of the filter output buffer is filtered.

At this point, a system may compute the filter that extracts the output waveform segment from the output buffer. This may be computed by dividing the output waveform segment by the output waveform buffer and is used to provide an index and a number of points in the output waveform buffer for extracting the output waveform segment.

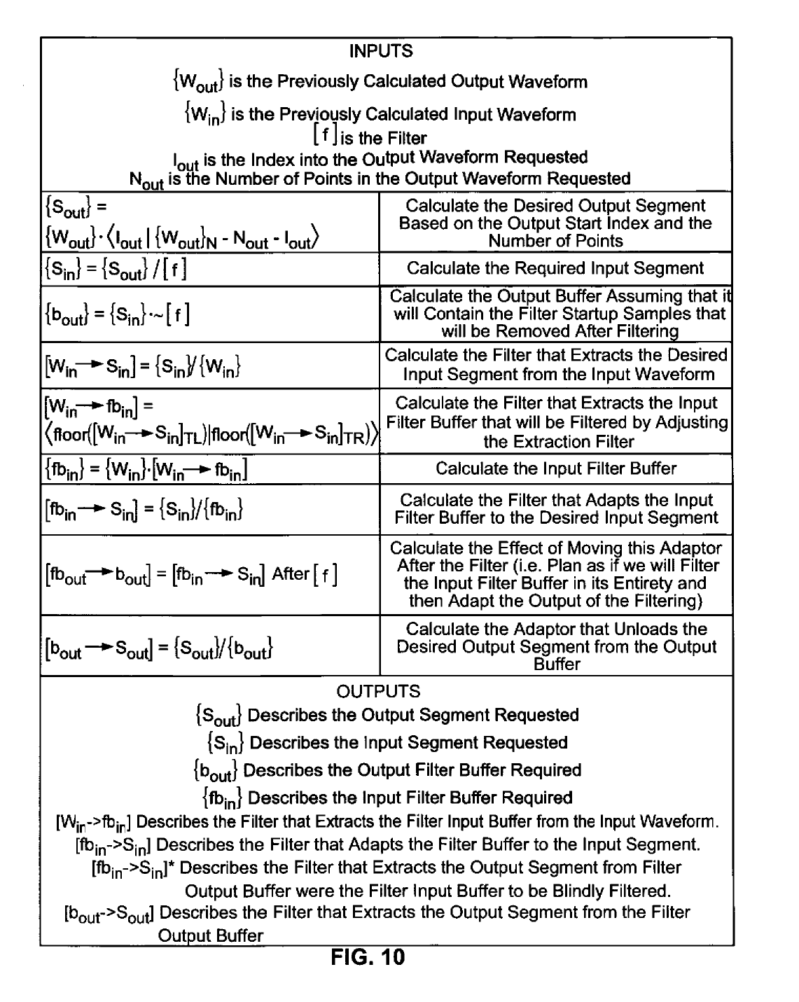

FIG. 10 shows an exemplary algorithm for determining processing requirements for a requested output segment. The depicted example shows steps to convert the input information into output information. Specifically, the input information may include items (e.g., filter) that are calculated once per waveform (e.g., input and/or output waveform), and items (e.g., the output start index and the number of points) that are calculated once per output waveform segment request.

The output information may include, for example, a number of new waveforms that pertain to the segment being calculated, namely the input and output waveform segment along with the input and output filter buffer. Additionally numerous waveform conversion filters may be calculated to transform any number of the waveforms, waveform segments, and buffers into others.

Other filters may be present in the processing chain. When a request has been made of a certain number of points from a certain start index of the output waveform, the next step upon making the calculations shown in FIG. 10 would be to calculate an output segment request for the preceding filter in the chain. Since the filter input buffer contains the actual points needed for the processing and since the input waveform for this filter in the chain may be the same as the output waveform for the filter preceding it, one may determine the index and number of points in the input waveform to the input filter buffer: the index into the input waveform is [wᵢₙ→fbᵢₙ]_{TL} and the number of points to take from the input waveform is {fbᵢₙ}_{N}. This information would be passed to the previous processing element in the chain and the entire calculation would be repeated for that element. Of course, the information calculated would be saved for use during subsequent segment processing.

At the time of processing, the input waveform segment at the beginning of the chain would be processed through the various filters and eventually, the processing would arrive at the present filter. There would be a buffer of waveform points representing the filter input buffer that was requested. An output buffer would be created and sized to hold the output and would be capable of storing {bₒᵤₜ}_{N} points. A call to the filtering function would be made with the address of the input buffer of points, the output buffer, and the number of points in the output buffer. If the filter element was an upsampler, one extra piece of information needs to be provided—the output sample phase for the first point. In the previous sections that described upsamplers and upsampling filters, I said that input samples may produce output samples starting at phase zero, which would be true if we were pushing the input waveform through the system, but in this case we are pulling data from the output and the desired phase may be considered. It turns out that the desired output sample phase is [fbₒᵤₜ→bₒᵤₜ]_{TL}. The reason why this is the case will become more apparent in a little while. After the output buffer is filled with filtered data, a next step may be to determine where the desired output segment is in the filter buffer so that the appropriate information can be passed to the next filter element. Since the desired output is {sₒᵤₜ} and the output buffer described by {bₒᵤₜ} contains the output data, the number of output points are {sₒᵤₜ}_{N} starting at index [bₒᵤₜ→sₒᵤₜ]_{TL} in the output buffer. The address of the filter output buffer at this index is what is passed to the next processing element.

When viewed from the perspective of a single filter in the processing chain, there is an input waveform {wᵢₙ} that, when applied to a filter [f] produces an output waveform {wₒᵤₜ}. In other words, {wᵢₙ}·[f]={wₒᵤₜ}. When an output waveform segment {sₒᵤₜ} is requested by index and number of points in {wₒᵤₜ}, then we are sure that {sₒᵤₜ} is truly a segment in {wₒᵤₜ} (provided the index is greater than or equal to zero and the index plus the number of points is less than the number of points in {wₒᵤₜ}. In the calculation of the input waveform segment, we preserve the relationship {sᵢₙ}·[f]={sₒᵤₜ}. The goal is to produce {sₒᵤₜ} such that the result of the calculation is the same whether we filtered {wᵢₙ} in its entirety and then extracted the segment {sₒᵤₜ} or filtered {sᵢₙ} directly.

Filter startup samples may be accounted for in the calculation, for example, by creating a filter output buffer {bₒᵤₜ} for filtering {sᵢₙ} and then creating a filter that extracts {sₒᵤₜ} from the output buffer. This may be done by creating a new relationship: {sᵢₙ}˜[f]={bₒᵤₜ} and {sᵢₙ}˜[f]·[bₒᵤₜ→sₒᵤₜ]={sₒᵤₜ} This new relationship allows for the actual physical filtering of {sᵢₙ} through [f]. Then, {sᵢₙ} may not actually exist in {wᵢₙ}. As mentioned, this may occur in the case that [f]_{U} is greater than unity. In this situation, a filter input buffer {fbᵢₙ} is created that meets the following criteria:
1. There is a trimmer [wᵢₙ→fbᵢₙ] with integer [wᵢₙ→fbᵢₙ]_{TL} and [wᵢₙ→fbᵢₙ]_{TR} that extracts {fbᵢₙ} from {wᵢₙ}.

2. {fbᵢₙ} is larger or equal to {sᵢₙ} (this is the same as saying that there is a filter [fbᵢₙ→sᵢₙ] such that [fbᵢₙ→sᵢₙ]_{TL}≧0 and [fbᵢₙ→sᵢₙ]_{TR}≧0 (neither necessarily integer).

This sets a new group of relationships: {wᵢₙ}·[wᵢₙ→fbᵢₙ]={fbᵢₙ}, {fbᵢₙ}·[fbᵢₙ→sᵢₙ]={sᵢₙ} and therefore {wᵢₙ}·[wᵢₙ→fbᵢₙ]·[fbᵢₙ→sᵢₙ]={sᵢₙ} This means: {wᵢₙ}·[wᵢₙ→fbᵢₙ]·[fbᵢₙ→sᵢₙ]˜[f]·[bₒᵤₜ→sₒᵤₜ]={sₒᵤₜ}

[fbᵢₙ→sᵢₙ] has been created with not necessarily integer point trimming and therefore cannot be physically realized. The non-integer nature may result from its location prior to the filter. Therefore, we move this filter beyond the filter by calculating [fbₒᵤₜ→sₒᵤₜ]=[fbᵢₙ→sᵢₙ] after [f] which may be equivalent to [fbₒᵤₜ→bₒᵤₜ]=[fbᵢₙ→sᵢₙ] after ˜[f]. By inspection of Equation 31, it may be seen that [fbₒᵤₜ→bₒᵤₜ]=[fbₒᵤₜ→sₒᵤₜ] since [fbᵢₙ→sᵢₙ]_{U}=1. Therefore, {fbᵢₙ}·[fbᵢₙ→sᵢₙ]·[f]={sₒᵤₜ} is equivalent to {fbᵢₙ}·[f]·[fbₒᵤₜ→sₒᵤₜ]={sₒᵤₜ} which is also equivalent to {fbᵢₙ}·˜[f]·[fbₒᵤₜ→bₒᵤₜ]={bₒᵤₜ} where [fbₒᵤₜ→bₒᵤₜ] can be physically realized: {wᵢₙ}·[wᵢₙ→bᵢₙ]˜[f]·[fbₒᵤₜ→bₒᵤₜ]·[bₒᵤₜ→sₒᵤₜ]={sₒᵤₜ}.

### Equation 44

### Blind Filtering Relationship

Equation 44 defines an exemplary relationship between the input waveform and the output waveform segment. It is called a blind filtering relationship because it shows the input waveform buffer {fbᵢₙ} filtered into an output buffer {fbₒᵤₜ} that still dose not represent the output buffer {bₒᵤₜ}. In other words the input filter buffer according to Equation 44 is filtered in a manner in which all of the possible output points that can be created by the input points contained in the filter buffer are created, without regard (or blind to the fact) that more filter output points were created than desired.

While it seems slightly inefficient to filter more points than is desired, you will see in the next section that this actually may create inefficiencies when utilizing the internal filter state to minimize calculation, for example. It may be preferable to filter as few points as is absolutely desired, for example, by filtering the desired points directly into {bₒᵤₜ}.

For example, [fbₒᵤₜ→bₒᵤₜ]_{TL} may be used as the phase of the first output point filtered and to filter only the number of points in {bₒᵤₜ}. Utilizing the phase manages the initial points in {fbₒᵤₜ} that would be trimmed from the front to produce {bₒᵤₜ}, and producing only the number of points in {bₒᵤₜ} obviates the need for trimming points from the back of {fbₒᵤₜ}. In summary, this causes the minimum number of output points to be produced by the actual filtering operation in the production of {sₒᵤₜ} assuming that the output segment requested is an isolated segment request and the filter startup samples may be accounted for.

In this manner, we find that while {wᵢₙ}·[wᵢₙ→fbᵢₙ}˜[f]={fbₒᵤₜ} where {fbₒᵤₜ} is not necessarily the same as {bₒᵤₜ}, processing {fbᵢₙ} through the filter and accounting for the output phase and output samples properly, actually produces {bₒᵤₜ}. Then we can use {bₒᵤₜ}·[bₒᵤₜ→sₒᵤₜ]={sₒᵤₜ} to extract the output segment.

The previous discussion allows for a more concise statement of the algorithm:

Given waveforms {wᵢₙ} and {wₒᵤₜ} and a filter [f] such that {wᵢₙ}·[f]={wₒᵤₜ} along with a request for Nₒᵤₜ points of {wₒᵤₜ} starting at index Iₒᵤₜ. We define [wₒᵤₜ→sₒᵤₜ]= [symbol] Iₒᵤₜ|{wₒᵤₜ}_{N}−Iₒᵤₜ−Nₒᵤₜ [symbol] as the filter that extracts {sₒᵤₜ} from {wₒᵤₜ}. We hold the key identities: {sᵢₙ}·[f]={sₒᵤₜ} and {sᵢₙ}·˜[f]={bₒᵤₜ} and create a filter that extracts the filter input buffer from the input waveform as:

[wᵢₙ→fbᵢₙ]= [symbol] floor([wᵢₙ→sᵢₙ]_{TL})|floor ([wᵢₙ→sᵢₙ]TR ) [symbol] and create the filter that would extract the output buffer from the filter output buffer as: [fbₒᵤₜ→bₒᵤₜ]=[fbᵢₙ→sᵢₙ] after [f] utilizing the fact that {wᵢₙ}·[wᵢₙ→fbᵢₙ]·[fbᵢₙ→sᵢₙ]={sᵢₙ}. Once these calculations have been made, Equation 45 is used that defines all of the extraction filters and buffer requirements during the filtering operation.

$${\{ {w}_{i n} \}}_{\begin{matrix}↑ \\ \{ {w}_{i n} \}\end{matrix}} \cdot {[ {w}_{i n} -> {fb}_{i n} ]}_{\begin{matrix}↑ \\ \{ {fb}_{i n} \}\end{matrix}} \cdot \sim {[ f ]}_{\begin{matrix}↑ \\ \{ {fb}_{out} \}\end{matrix}} \cdot {[ {fb}_{out} -> {b}_{out} ]}_{\begin{matrix}↑ \\ \{ {b}_{out} \}\end{matrix}} \cdot {[ {b}_{out} -> {s}_{out} ]}_{\begin{matrix}↑ \\ \{ {s}_{out} \}\end{matrix}} = {\{ {w}_{out} \}}_{\begin{matrix}↑ \\ \{ {w}_{out} \}\end{matrix}} \cdot {[ {w}_{out} -> {s}_{out} ]}_{\begin{matrix}↑ \\ \{ {s}_{out} \}\end{matrix}} \\ Segment Processing Equation \qquad Equation 45$$

Note that all of the buffers and extraction filters in Equation 45 are physically realizable.

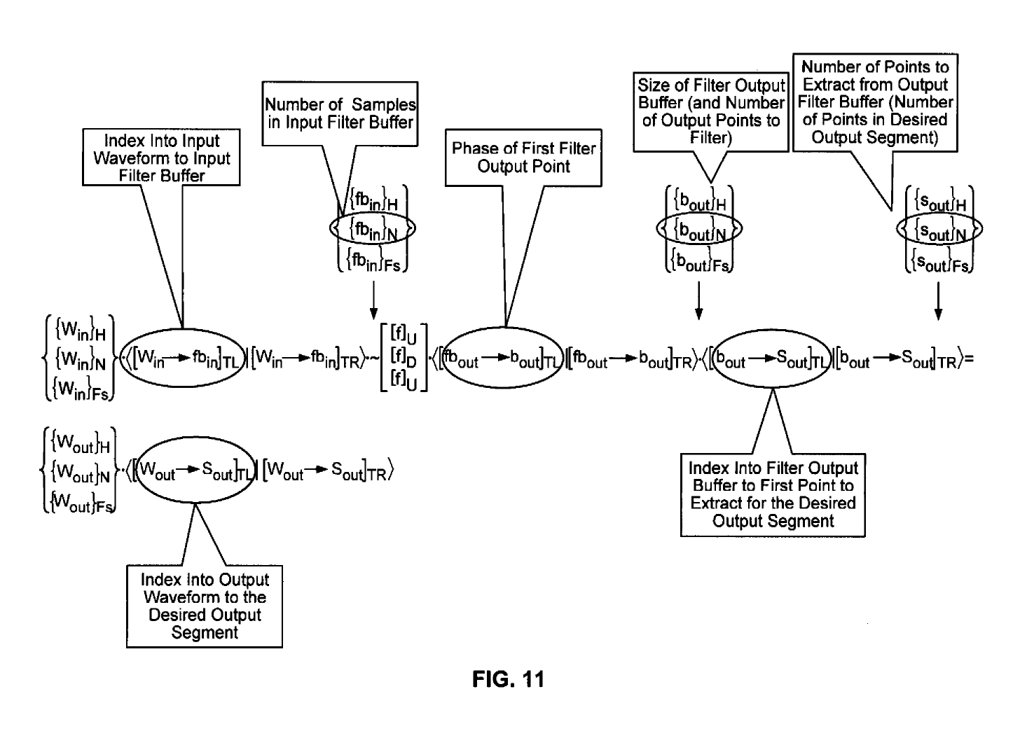

FIG. 11 illustrates an exemplary process for deriving segment filtering instructions from a segment processing equation. The example depicted in FIG. 11 shows the segment filtering instructions that are derived from the segment processing equation provided in Equation 45. FIG. 11 shows information that is derived from the various waveforms, buffers, segments and filters that have been calculated for the processing of the desired output segment.

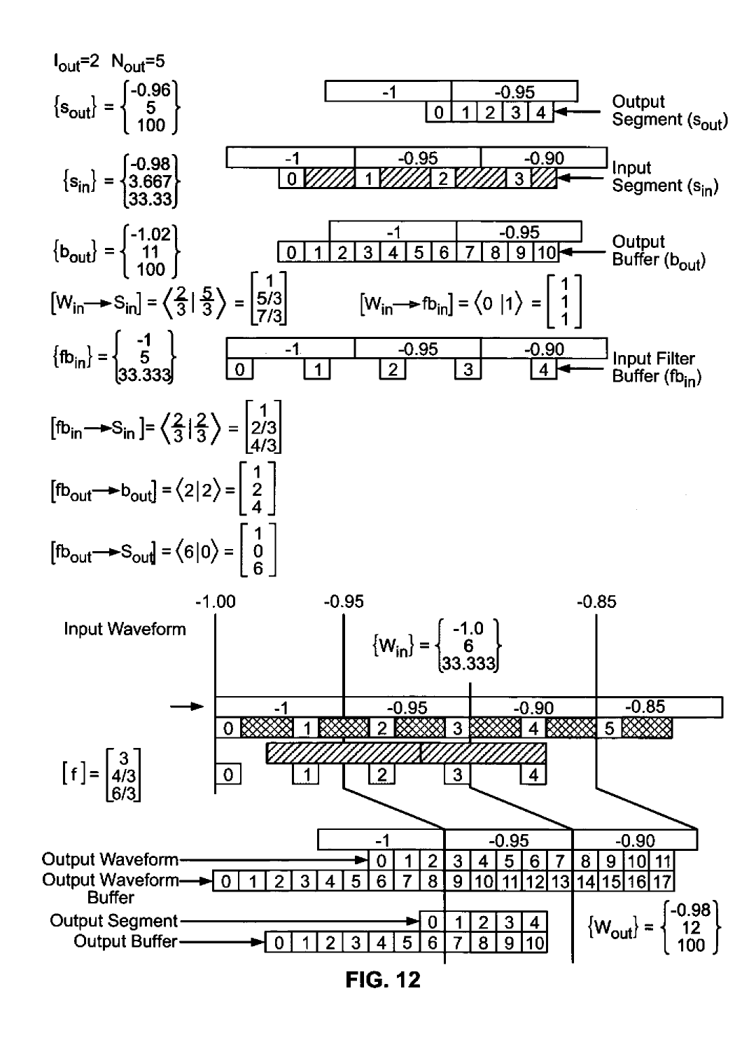

FIG. 12 shows an exemplary calculation showing exemplary processing requirements. In this example, a five point input waveform is processed with an upsampling filter that upsamples by a factor of three. The output waveform is twelve points. The diagram is arranged to exhibit a dual time scale: an input time scale and an output time scale that is delayed in time. This arrangement is intended to show which input points produce which output points.

In this example, five output points are requested, starting at index two of the output waveform. This creates the five point output waveform segments shown. When we look backwards through the filter to calculate the input waveform segment, we find that the waveform segment not only contains a fractional number of input points, but is not even in the same sample phase as the input waveform. As such, this waveform segment cannot be readily extracted from the input waveform.

In a general example, the points may be filtered in a manner to produce the output buffer that would be produced if this input waveform segment had been filtered without removing the startup samples of the filter. Accordingly, the output buffer is calculated from the input segment. In this example, it is an eleven point buffer. This is not surprising because even though the filter has two startup samples, the startup samples are referred to the filter input. When the upsample factor is accounted for, we see that the filter removes six points from the output waveform.

Now, we calculate the filter that extracts the input waveform segment from the input waveform and constrain it to remove an integer number of points from the input waveform. This filter, when applied to the input waveform produces the filter input buffer shown. We can see that the filter input buffer is larger than the input waveform segment and contains actual points in the input waveform.

Since the filter input buffer contains points in the input waveform, we know that the number of points taken from the input waveform is identical to the number of points in the filter input buffer. Furthermore, the index into the input waveform to the points needed is calculated by calculating the index in the input waveform to index 0 in the input filter buffer. These would be the points requested from any upstream processor—five points from index 0.

The filter that extracts the input waveform segment from the filter input buffer is calculated and moved after the filter. We can see that this filter wants to trim two points from the left of the filter output, so we use a phase of two for the filtering operation. You can see visually that if the filter input buffer is filtered with eleven output points specified with a starting phase of two into the output buffer, then the waveform described by the output buffer waveform is produced. The number of usable points in this output buffer is the number of points in the output waveform segment (five). The index into this buffer to these five points is the number of points trimmed from the left by the filter that converts the output buffer to the output waveform segment. We can see that this is six.

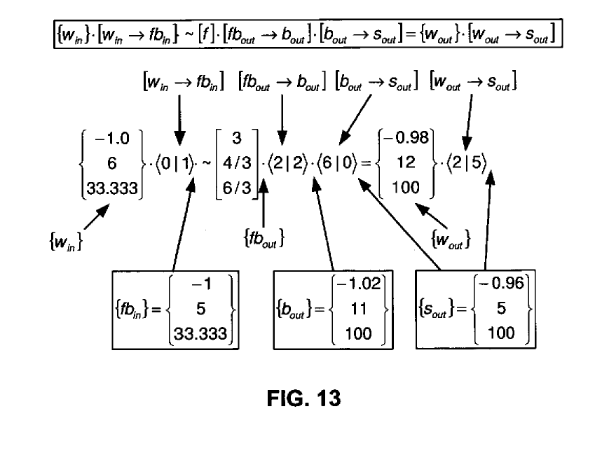

FIG. 13 shows an exemplary filtering requirements calculation. In particular, FIG. 13 shows exemplary waveforms, buffers, segments and filters associated with FIG. 12.

The previous section outlined a method and algorithm for producing output waveforms in segments. As such, the previous section outlined a method suitable for random access of waveform output segments. While random access of waveform output segments is certainly one of the advantages of the pull system architecture, it is not the typical access method. Some access methods may be further optimized for speed.

While it may be true that several small pieces of the output waveform might be requested, the processing requirements of these small segments are small, even when the filter startup samples may be accounted for. The general operation is that all or a large piece of the output waveform may be assembled and the segmented processing is utilized for memory cache operation. It is the production of large output waveform pieces that may be optimized.

In an illustrative example, the operation is as follows: Input waveforms are produced by the waveform digitizing system and presented to the processing chains. At the time, the output waveform of a processing chain is calculated. Then, the system pulls segments of the output waveform from the output of the processor. These segments are possibly small with respect to the total output waveform size, and are requested in order. This illustrated by a simple example. If, for example, a 1 Megapoint waveform is presented to the input of a processor. The output waveform is computed to be 800 Kilopoints. The system might process this waveform by requesting 8000 points starting at index 0, then another 8000 points starting at index 8000, then another 8000 points starting at index 16000, etc. This allows the output waveform to be assembled in 8000 point segments.

In the method provided in the previous section, each processor calculates an input waveform segment by looking backwards through the filter. However, the filter is specified with startup samples that may be removed from the output buffer to produce the output waveform segment. In the example in the previous section, we produced eleven points and kept only five of them.

This seems like an unavoidable inefficiency unless the internal filter tap state is considered. Filters generally contain delay taps internally that store the state of the filter. In the case of the FIR filter, some computation may be avoided by preloading the delay taps with earlier input filter buffer points and only filtering the points needed, but in the more general case, when the IIR filter is considered, preloading the state may involve processing startup samples.

If the filter state is retained, the filter may be anticipating or expecting its next input. For example, suppose that we have a ten tap FIR and 100 output points are produced in an output waveform starting at index zero. In other words, I have produced index zero through of the output waveform. At that point in time, the filter is remembering the last ten samples (they are loaded in the delay taps) and in order to produce the next 100 points, all that is needed is to filter them directly. There is no need, in some examples, to filter 110 points and then remove the first ten. As such, the index of the last waveform produced by the filter marks the state of the filter.

Some systems may substantially maintain the internal filter tap states to reduce or substantially minimize the amount of calculation needed to process contiguous waveform segments.

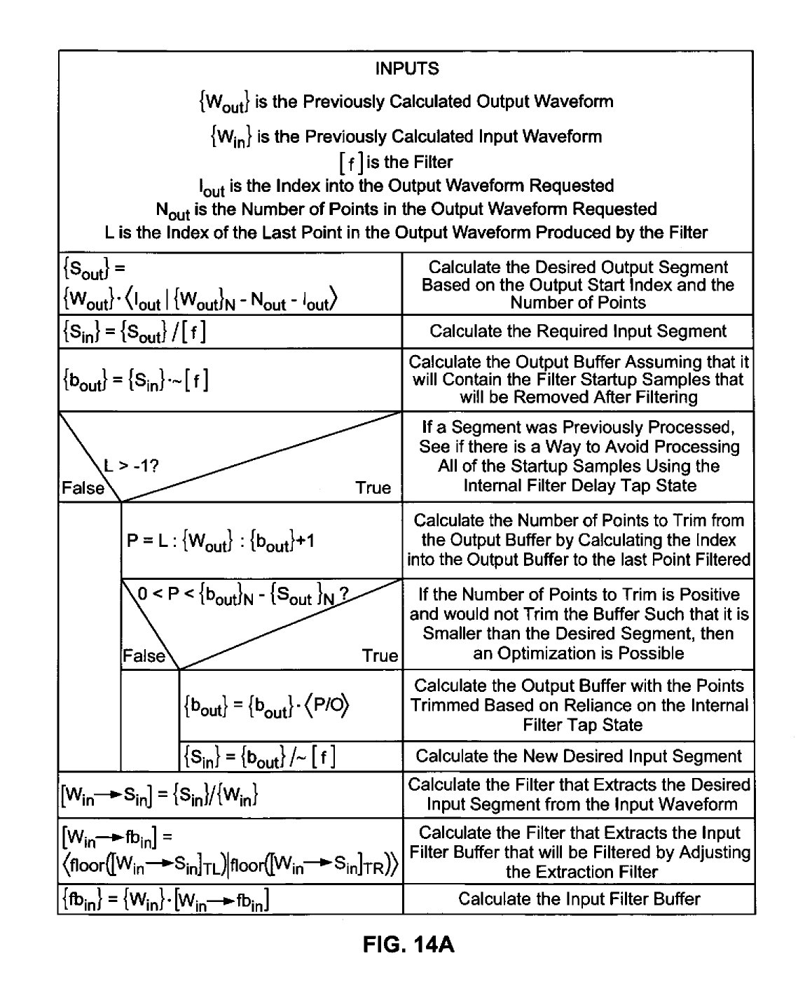

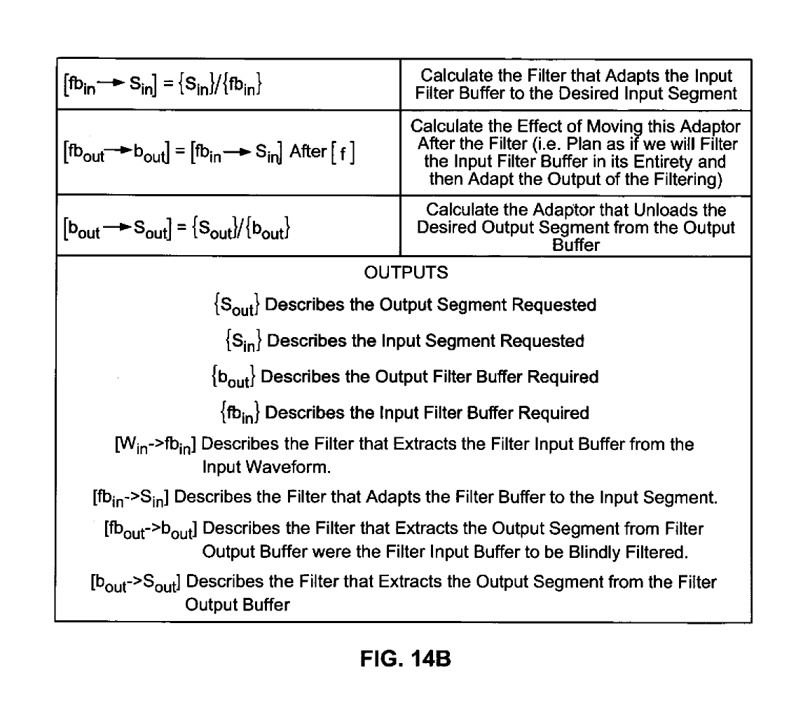

FIG. 14 shows an exemplary algorithm similar to FIG. 10, with additional calculation provided for providing optimization based on internal filter state.

FIG. 14 provides one additional input when compared to FIG. 10. A variable L holds the index of the last output waveform point produced by the filter. When the filters are first initialized, L is set to −1. This causes the first buffer to be calculated with all startup samples accounted for because a negative output index is impossible. After a buffer is calculated, L is set to:

L={bₒᵤₜ}_{N}−1:{bₒᵤₜ}:{wₒᵤₜ}

### Equation 46

### Calculation of Last Output Waveform Point Calculated

The additional calculation in 14 can be added, with the capability of disabling this optimization by simply avoiding the calculation of L in Equation 46 after each buffer is calculated.

In FIG. 14, {sᵢₙ} is originally calculated with startup samples accounted for which causes {bₒᵤₜ} to contain the extra filter startup samples. Then, when L>−1, the equivalent index in {bₒᵤₜ} is calculated (the points to trim: P is the index plus one). P represents a potential number of samples to avoid filtering because of the internal filter state. If the number of points P is positive and does not reduce the size of {bₒᵤₜ} such that it is smaller than {sₒᵤₜ}, then the P points are trimmed from {bₒᵤₜ} and {sᵢₙ} is recalculated to account for the new {bₒᵤₜ} by looking back through the filter.

In FIG. 14, you can see that when the appropriate conditions on P are met, {bₒᵤₜ} is redefined as {bₒᵤₜ}={sₒᵤₜ}·[f]⁻¹·˜[f]· [symbol] P|0 [symbol] which is equivalent to

$$\{ {b}_{out} \} = \{ {s}_{out} \} \cdot {[ f ]}^{- 1} \cdot \sim [ f ] \cdot [ \begin{matrix}1 \\ 0 \\ {[ f ]}_{s}\end{matrix} ] = \{ {s}_{out} \} \cdot {[ f ]}^{- 1} \cdot [ f ] = \{ {s}_{out} \} and \{ {s}_{i n} \}$$

is redefined as {sᵢₙ}={bₒᵤₜ}/˜[f] when the output segments are accessed contiguously and in increasing time order. Since {sₒᵤₜ}={bₒᵤₜ}, [bₒᵤₜ→sₒᵤₜ]=[I] and a new equivalent filter processing equation arises and is shown in Equation 47. Equation 47 should be compared with Equation 45.

$${\{ {w}_{i n} \}}_{\begin{matrix}↑ \\ \{ {w}_{i n} \}\end{matrix}} \cdot [ {w}_{i n} -> {fb}_{i n} ] {\cdot }_{\begin{matrix}↑ \\ \{ {fb}_{i n} \}\end{matrix}} \sim [ f ] {\cdot }_{\begin{matrix}↑ \\ \{ {fb}_{out} \}\end{matrix}} {[ {fb}_{out} -> {b}_{out} ]}_{\begin{matrix}↑ \\ \{ {b}_{out} \} = \{ {s}_{out} \}\end{matrix}} = \{ {w}_{out} \} {\cdot }_{\begin{matrix}↑ \\ \{ {w}_{out} \}\end{matrix}} {[ {w}_{out} -> {s}_{out} ]}_{\begin{matrix}↑ \\ \{ {s}_{out} \}\end{matrix}} \\ \begin{matrix}Equivalent Segment Processing Equation When Output Segment \\ Are Processed Contiguously\end{matrix} \qquad Equation 47$$

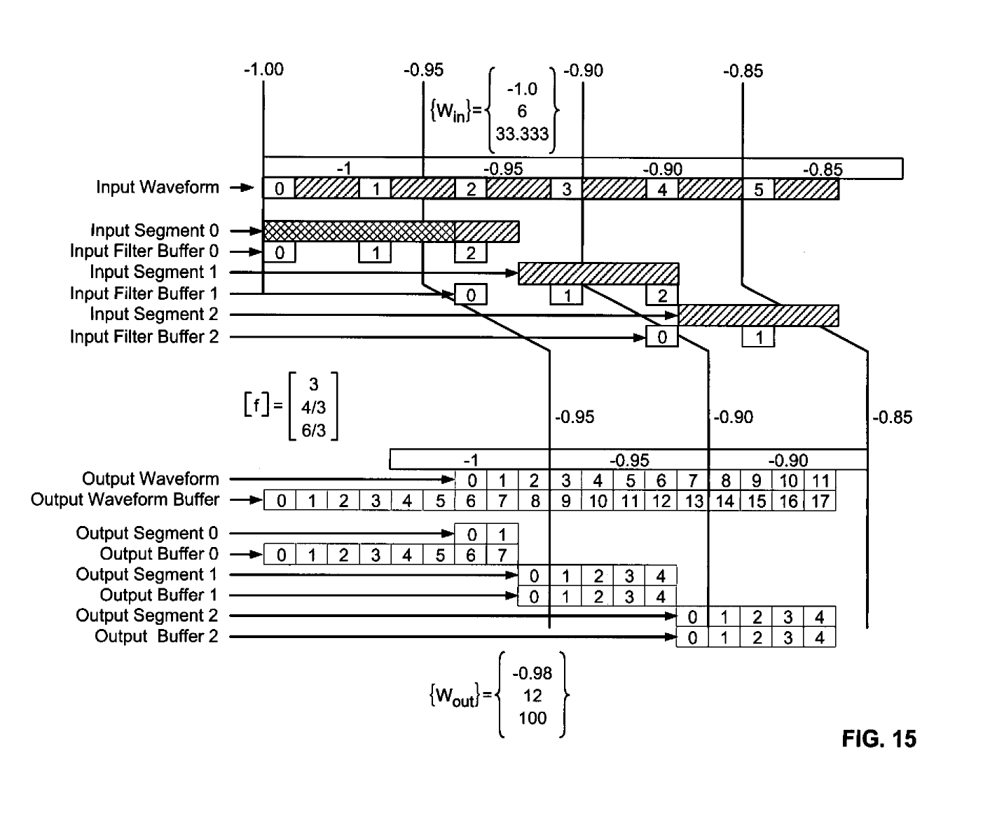

FIG. 15 shows an exemplary calculation as in FIG. 12 that further includes internal filter state optimization. In particular, FIG. 15 shows an example as in FIG. 12, but introduces three contiguous output waveform segments processed to produce the entire output waveform.

In FIG. 15, the exemplary first output segment request (segment 0) includes two points starting at index zero of the output waveform. This output segment request results in the processing of startup samples. After the filtering of segment 0, the last output waveform point filtered is retained as L=1. The example in FIG. 12 showed the processing of segment 1 in FIG. 15 without the benefit of the internal filter state optimization. In FIG. 12, you can see that the index L=1 in the output waveform corresponds to index 5 in the output buffer, meaning that the optimization wants to trim six points from the front of the output buffer. These six points were the extra points required for the filter startup samples and you see that this optimization eliminated the need to filter these points.

In FIG. 15 with the internal filter state optimization, the processing of the output waveform segment by segment resulted in exactly the same amount of computation were the output waveform computed by filtering the entire input waveform in one shot.

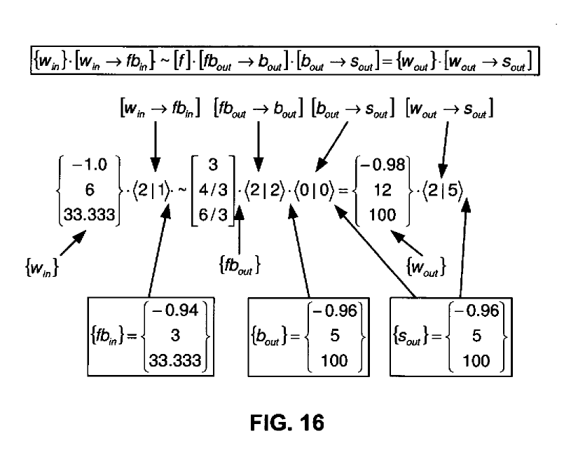

When utilizing the internal filter state optimization and when output waveform segments are requested such that each segment is contiguous with the last in and in time order, the amount of calculation required may be substantially reduced or minimized. FIG. 16 shows an exemplary filtering requirements calculation for contiguous processing of a segment 1.

In the example depicted in FIG. 16, the output waveform is requested in three contiguous segments and the processing of the waveform flowing through this filter element is minimized. However, the input filter buffer is not requested as contiguous segments from the input. This means that while the processing of waveform segments at this point in the processing chain has been minimized, upstream processing elements may not take advantage of this optimization.

To substantially reduce or absolutely minimize the calculations, a system may be configured such that the output segments are requested contiguously and in time order. This may be explained with reference to two cases in which the system breaks down when the output segments are almost, but not contiguous.

The first case to examine is the case where slight gaps appear between the output segment requests. Taking the example in FIG. 15, consider what happens if the segment 1 request is a request for five points starting at index three in the output waveform (instead of five points from index two as was requested in the example). This causes a single point gap and the output waveform segment requested is not contiguous with the previous segment. In this situation, the output buffer calculated before the application of the internal filter state optimization is delayed one sample in the output waveform, and the index L=1 in the output waveform forms and index of four in the output buffer and the internal filter state optimization wants to trim only five points from the output buffer. The system properly adapts to this situation by filtering only one extra startup sample that is removed from the output buffer to form the output segment requested. As such, we see that the exemplary system may be resilient to small gaps in the output segment requests.

After the processing of the points in segment 1, the index L is updated as L=7 in this case. In another example, segment 2 may be requested exactly as in FIG. 15 following this situation. Segment 2 is a request for five points starting at index 7. The output buffer calculated prior to the internal filter state optimization is eleven points starting at index one of the output waveform and the index L=7 in the output waveform forms an index of six into the output buffer, thus requesting that seven points be trimmed from the buffer for the optimization. However, seven points trimmed from this eleven point buffer leaves only four remaining points, making it smaller than the output segment requested, the optimization fails, and no points are trimmed. In this situation, all of the startup samples would be filtered.

The reason for the failure of the optimization in this case can be understood by reconsidering how the filters operate. Filters operate by presenting an input sample to the filter, calculating an output sample, then shifting the input sample (and the other samples held in the delay lines) to the next delay tap. This is how the filter state is preserved. When requests are made to filter a point that is already inside held inside the filter, we have lost the opportunity calculate the output point. In other words, the filter may often be configured such that reversing the flow through the filter taps is not generally feasible.

Benefits of the internal filter state optimization may include minimizing the amount of computation of the output waveform when the output waveform is calculated in contiguous output segments in increasing time order. If there are slight gaps between the output segments requested, the system remains resilient, but if there is even slight overlap of output segments requested, the optimization may fail at these overlap points and filters are flushed by calculating all of the startup samples necessary, which may cause upstream failure of this optimization.

To substantially avoid such failure of the optimization, one may simply follow the rules and request contiguous output segments that are increasing in time. However, as shown in FIG. 15, while these rules may be obeyed on the output segment requests, the filter in this example is not obeying these rules on its input buffer requests. It requested three samples from index zero of the input waveform for segment 0, three samples from index 2 of the input waveform form for segment 1, and two samples from index 4 of the input waveform for segment 2. All of these input waveform buffer requests are overlapping segment requests for the upstream processor and no internal filter state optimization will be performed on any processor upstream from this one as failure of the optimization at any processor may mean failure at some or all processors upstream.

In some embodiments, the internal filter state optimization may cause the amount of filter computation to be substantially minimized when output segment requests are contiguous and increasing in time. Some processors do not obey these rules on input buffer requests. In the example shown in FIG. 15, the input waveform segments requested were not contiguous segments and had a single point overlap at the beginning of the filter input buffer with the previous filter input buffer request, causing failure of the internal filter state optimization in all processors upstream.

It turns out that this request for overlapping input segments may only be the case when the filtering element increases the sample rate, hence the usage of an upsampling filter in all of the examples. It also turns out that the possibility for overlap in the input buffer requests is generally greater than a single point at the front of the filter input buffer.

Various embodiments may advantageously include an input buffer caching element.

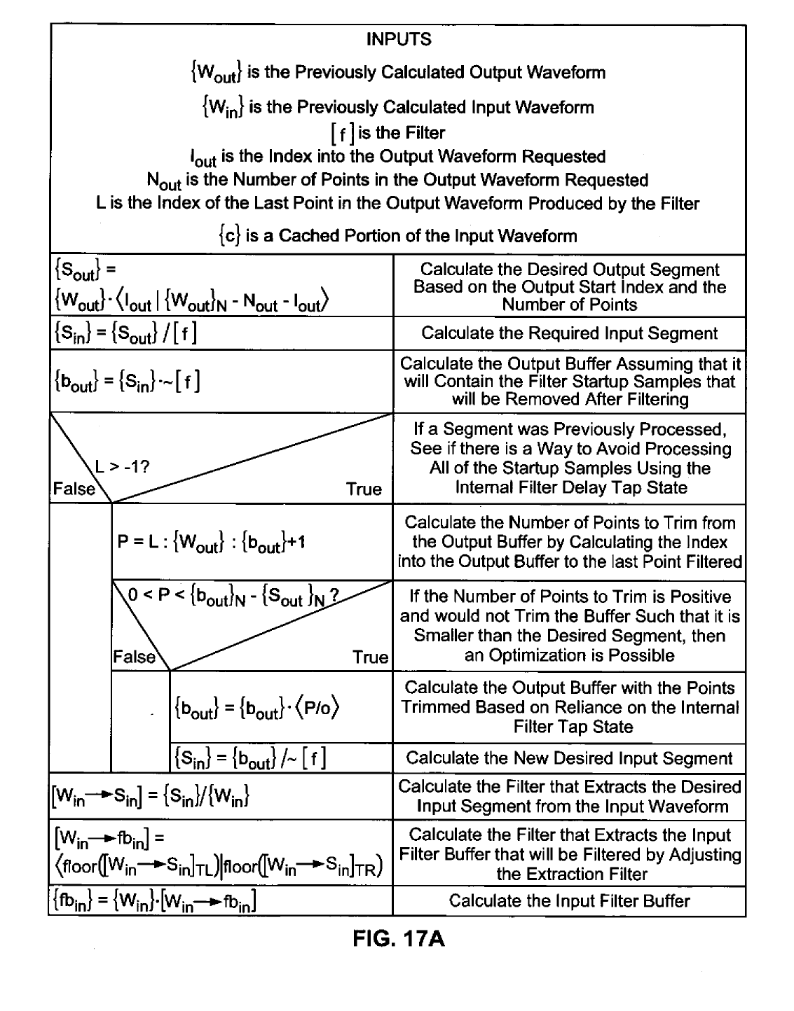

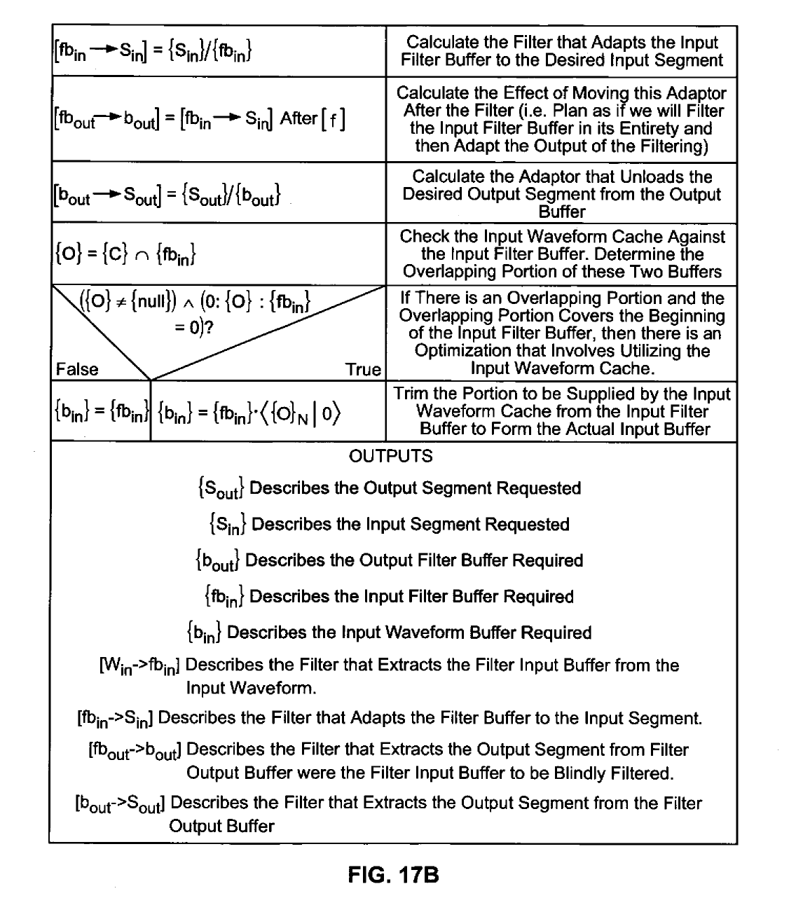

FIG. 17 shows an exemplary algorithm as in FIG. 14 that further includes an embodiment of input buffer caching. In this example, FIG. 17 shows the additional calculation required for the implementation of input buffer caching. At this point, a distinction may be made between {bᵢₙ} and {fbᵢₙ}. In FIG. 17, {bᵢₙ} becomes the new input buffer that is actually requested from the input waveform and therefore forms the upstream output segment requests. {fbᵢₙ} retains its usage as the actual buffer applied to the filter, but is no longer necessarily equivalent to {bᵢₙ} and may contain one additional point at the beginning.

In general the input and output waveforms, segments and buffers have had consistent naming conventions, such as {wᵢₙ}, {sᵢₙ} and {wₒᵤₜ},{sₒᵤₜ} for the input and output waveform segments, respectively with the exception of {fbᵢₙ} and {bₒᵤₜ}. With reference to discussion of input buffer caching, {bᵢₙ} represents the buffer requested from the input, and {fbᵢₙ} represents an internal element that contains the buffer actually applied to the filter.

Utilizing the algorithm in 17, after forming of the input filter buffer for the processing of a segment, the last point in the input buffer is utilized to update the single point input buffer cache. This is performed by extracting the single point at index {bᵢₙ}_{N}−1 of the input buffer (if there are any points in it) and storing it. The definition of the point is retained as {c}={bᵢₙ}· [symbol] {bᵢₙ}_{N}−1|0 [symbol] . Before any processing takes place, it is initialized to {c}={null}.

When the calculation for each output segment request is performed, the overlap {o} between the cached element {c} is calculated. If there is overlap, a check is made to ensure that the overlap covers the beginning of the filter input buffer. If this is the case, then the overlapping section can be trimmed from the input filter buffer to form the actual input buffer request. The actual input buffer request is now made from {bᵢₙ}. In other words, {bᵢₙ}_{N} points are requested from the input waveform starting at index 0:{bᵢₙ}:{wᵢₙ}.

Some examples may illustrate calculations for a single point cache for purposes of clearly describing features and aspects of some embodiments. In such examples, only a single point may be needed to maintain internal filter state optimization throughout the chain. However, various embodiments may be implemented using, for example, an input buffer cache of an arbitrary length.

When the input buffer arrives, it is copied into the end of the input filter buffer sized appropriately to hold {fb}_{N} points and the overlapping portion {o} in the input buffer cache {c} is copied into the front of the filter buffer. Once this is done, the input buffer cache can be updated. Then processing proceeds as explained elsewhere herein.

$${( \{ {w}_{in} \} \cdot [ {w}_{in} \to {b}_{in} ] ⋃ \{ o \} ) \sim [ f ] \cdot [ {fb}_{out} \to {b}_{out} ] \cdot [ {b}_{out} \to {s}_{out} ]}_{\begin{matrix}{ \{ {w}_{in} \} }^{ ↑} & { \{ {b}_{in} \}}^{ ↑} & { \{ {fb}_{in} \}}^{ ↑} & { \{ {fb}_{out} \}}^{ ↑} & { \{ {b}_{out} \}}^{ ↑} & { \{ {s}_{out} \}}^{↑} & { \{ {w}_{out} \}}^{↑} & { \{ {s}_{out} \}}^{ ↑}\end{matrix}} = \{ {w}_{out} \} \cdot [ {w}_{out} \to {s}_{out} ] \\ Equivalent Segment Processing Equation When Input Buffer Caching Is Utilzed \qquad Equation 48$$

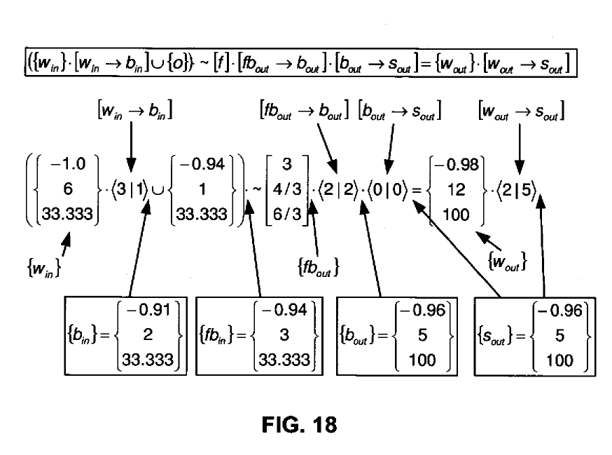

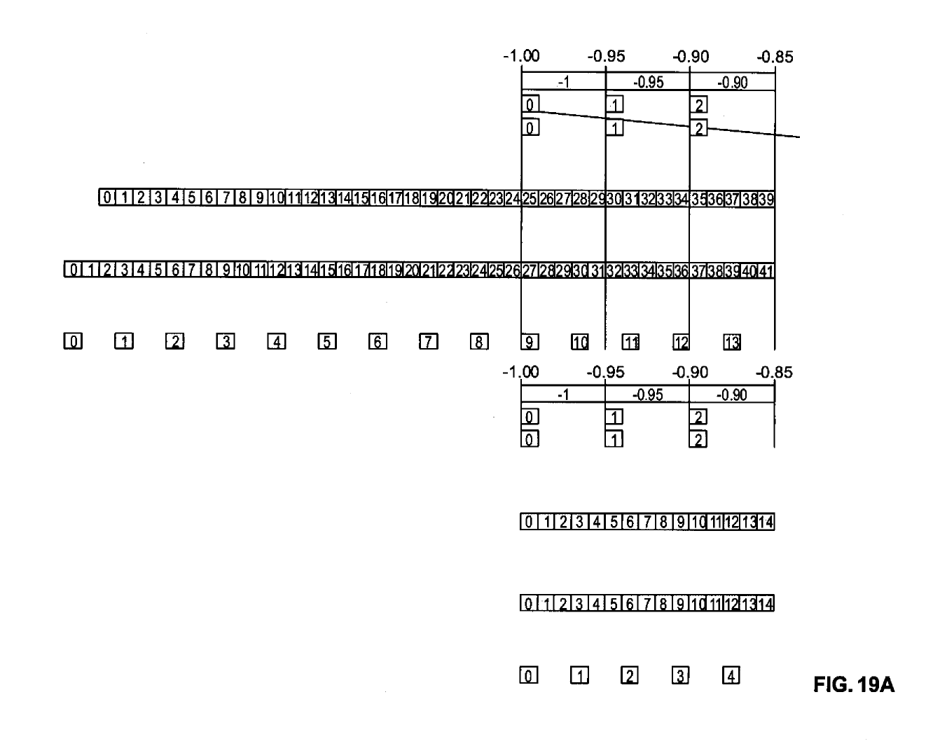

FIG. 18 shows an exemplary filtering requirements calculation for contiguous processing of a segment 1 that further includes input buffer caching. In particular, FIG. 18 shows an example in which input buffer caching results in the input buffer requests becoming three points from index 0 for segment 0, two points from index 3 for segment 1, and one point from index 5 for segment 2. The input buffer requests are all request for contiguous, time increasing segments of the input waveform and the internal filter state optimization is preserved all the way up the processing chain.

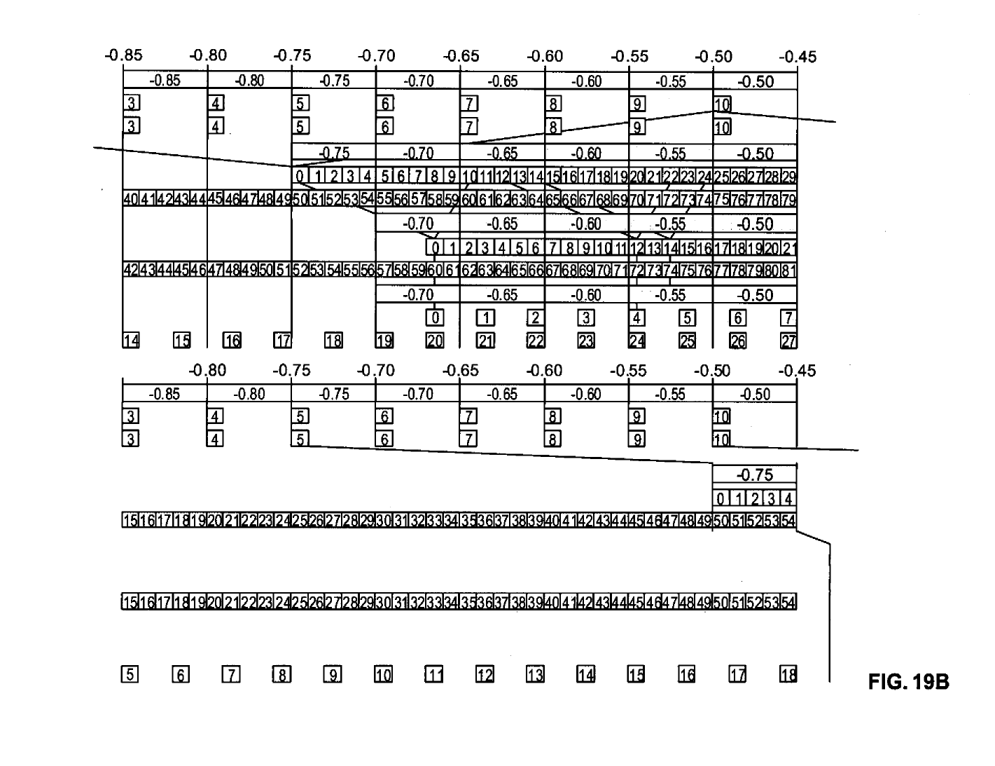

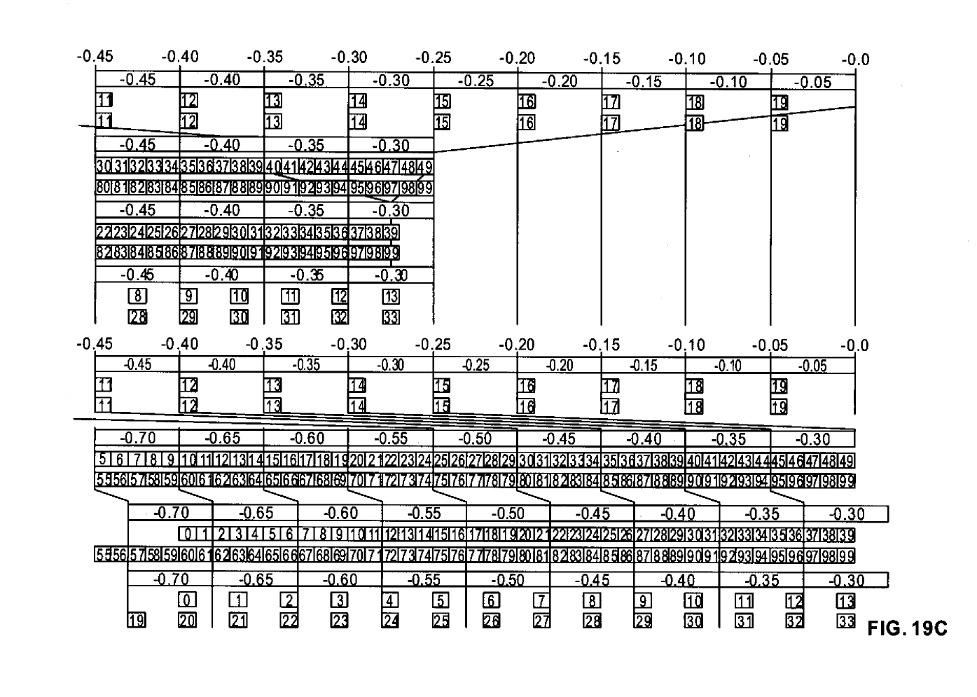

FIGS. 19A-19B show an example plot illustrating an exemplary processing scenario according to one embodiment.

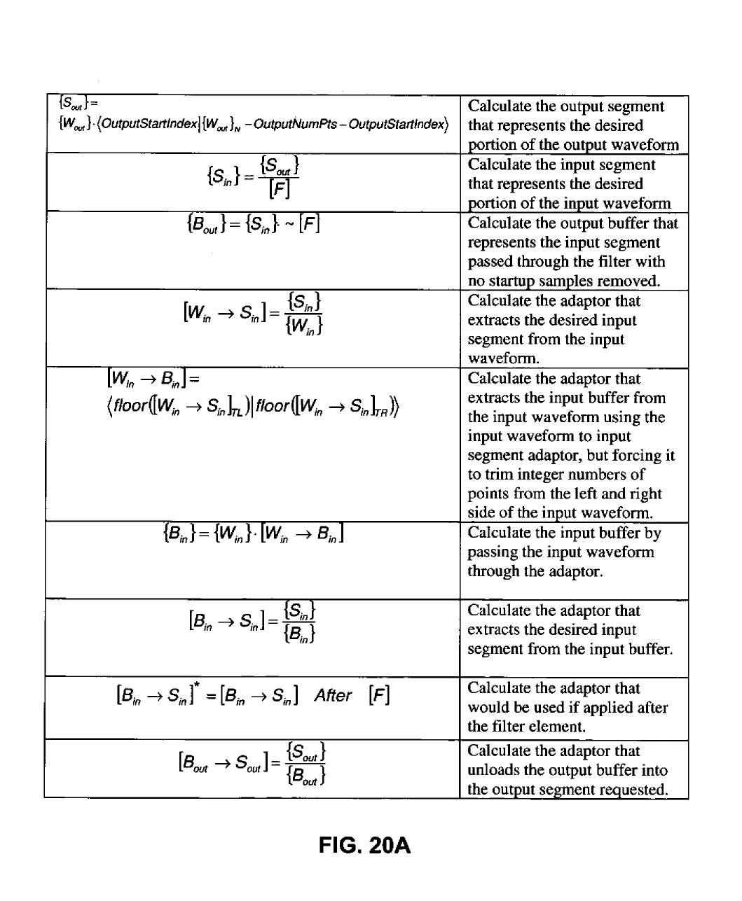

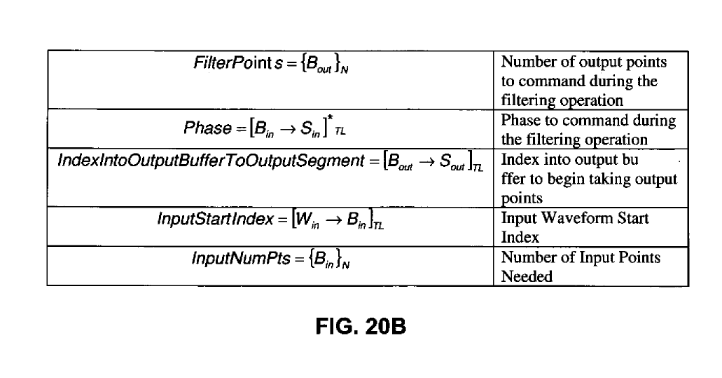

FIGS. 20A-20B show exemplary steps for processing a waveform to produced a selected number of output points in a desired portion of an output waveform.

First, a selection is made to identify a desired number of output points (e.g., OutputNumPts) to form a desired portion of the output waveform. This may determine a starting location (e.g., OutputStartIndex) of the output waveform.

The next step is to create an input buffer that is InputNumPts long and get that many points from the input starting at InputStartIndex. If there is a processing element prior to this one, the previous IndexIntoOutputBufferToOutputSegment may be used as an index into the previous processing elements output buffer, which should contain exactly InputNumPts (e.g., InputNumPts should be the same as OutputNumPts of the previous processing element).

The next step is to create an output buffer that is FilterPoints long. Then call the filtering function. The called filtering functions may take as arguments a pointer to the input buffer, the number of output points to produce from the input buffer, and optionally, the phase. The filtering functions may produce a given number of output points. The processing system provides an appropriately-sized input buffer. A pointer points to the beginning of the input buffer containing the actual input buffer points. The processing system provides FilterPoints as the number of output points, and optionally provides the phase. After the call, the output buffer contains FilterPoints worth of output data. The IndexIntoOutputBufferToOutputSegment indexes the first point in the buffer that corresponds to the point in the output waveform indexed by OutputStartIndex and the OutputNumPts is the number of output points to take from the output buffer.

Although various embodiments have been described above, other implementations are contemplated. For example, multiple waveforms of analog and/or digital data may be sampled in parallel, using one or more sampling modules. In various implementations, such sampling modules may include hardware, software, firmware, or a combination thereof to perform operations that may include, but are not limited to, signal conditioning, sample-and-hold, track-and-hold, analog-to-digital conversion, multiplexing, provide operating power, filtering (e.g., amplification, buffering, limiting, offset, mixing, and the like), data storage, auxiliary operations, and/or a combination of these or other functions. Each waveform may be sampled at one or more frequencies, which may be substantially synchronized, delayed, and/or independent of the sampling of one or more other waveforms.

Various embodiments may be implemented in a variety of applications. In several implementation examples, simulation software packages, analog video waveform processing, or analog audio processing, may process, for example, a substantial amount of time-ordered pairs of sequential data could take advantage of the speed performance improvements. Such improvements may result, for example, from improved cache utilization efficiency potential of a pull processing architecture combined with the substantially reduced filter start up time associated with an embodiment of the tap filter initialization capability.

In some implementations, portions of a sampled waveform may be processed with one or more other waveforms or data sets. Waveforms to be processed together may be captured during over-lapping or non-overlapping times.

In various implementations, a number of processing steps may be performed in a sequence, and one or more sequences may be performed in parallel, series, or a combination thereof. The outputs of a sequence of one or more processing steps may be provided as inputs to one or more processing steps. Each processing step may generate one or more output signals, which may include a filtered waveform, for example.

In a processing sequence, one or more processing steps may be configured to perform as a pull or a push architecture, or a combination thereof. Memory sizes may be computed for data stores (e.g., buffers, caches, registers, RAM, NVM) before, during, or after the request to pull data is sent. Tap states may be optionally stored in a shift register, parallel register, or in a combination of these or other data stores. In some embodiments, the tap filter state information may be obtained by maintaining in the filter one or more points left over from the previously processed waveform segment.

Data may be pulled in any order, which may include first-in-first-out, last-in-first-out, in a random manner, sequentially, reverse, according to a priority, or in an user-specified order, for example. User-specified data may include data to be sent for display on a display device, such as a plot of a digital or analog waveform after processing by the processing elements.

For example, some embodiments may be implemented using an input buffer cache length sized to avoid overflow of a selected buffer space. For example, various implementations may operate to dynamically or statically size input buffer cache length to avoid overflow of, for example, to an L cache, L2 cache, L1 cache. In other implementations, other fast access memory types may be used. In some embodiments, the processing segments may be sized such that all processing is performed using data stored in the selected cache. For example, a segment may be substantially fully processed by a stage in the processing chain without accessing a longer access time memory space. In some embodiments, a filter may be initialized by tap filter state information obtained from a second memory space external to the cache memory space before processing the segment using data obtained from the selected cache memory.

In various embodiments, filters may be implemented in hardware (e.g., buffers, shift registers, a hardware stack, or the like), in software (e.g., using pointers), or a combination of these or other discrete and/or integrated circuitry (e.g., digital signal processors, math coprocessors, parallel processors, or the like). Some implementations may include circuitry implemented in ASICs (application-specific integrated circuits) or field programmable gate arrays, for example.

In some implementations, the input buffer size may be selected initially or set to a default or fixed value suitable for a particular condition. In various embodiments, the length of an input segment may be selected, for example to make substantially maximum use of available cache size while processing each segment in the processing chain using substantially only data from cache hits. Some implementations may include a dynamically adjustable configurable input buffer size selection.

In some cases, an input buffer length may be advantageously selected once or as a variable, for example, that is a function of the state or changes in the processing chain (filter number, type, characteristics, configuration), sampling rate, available cache size and speed, numerical precision, computational bandwidth, decimation, or a combination of these and/or other factors. Some implementations may, for example, calculate the maximum buffer size required during segment processing. If the calculated maximum buffer size is greater than the available cache buffer size, then the input buffer size (e.g., InputNumPts) may be decreased until a buffer size is identified that would not exceed the available cache size. If the calculated maximum buffer size is less than the available cache buffer size, then the input buffer size may be increased until a buffer size is identified that would exceed the available cache size. Various search methods (e.g., golden section search, linear increment, or the like) may be used to identify the largest input buffer size that may be used to process the waveform segments using substantially only cache hits.

Cache hits may be generally understood to refer, at least in some embodiments, to accesses of data directly from a memory space that provides substantially minimal data access time for a processor. Cache hits generally do not involve a cache fill operation to retrieve additional data into the cache. Various types of memory may be used for cache and non-cache memory, depending on available hardware and configuration of the processing system. The processing system may include, for example, one or more types of memory devices, including one or more memory spaces, processing modules (e.g., digital filters) arranged to receive, process, and output segments of time-ordered data. The data may be received at an input, processed (e.g., filtered), and provided at an output. One or more outputs of one or more modules may be coupled to inputs of one or more other modules, for example, in parallel and/or series configurations. Some systems may include feedback.

Processing modules may process data, which may be time-ordered sequential and contiguous, for example. Some systems may process segments and/or portions of waveform data starting with more recent data before processing older data, or vice versa.

Various embodiments may include aspects of a computer. The essential elements of a computer are a processor for executing instructions and one or more memories for storing instructions and data. Suitable processors for the execution of a program of instructions may include, by way of example, both general and special purpose microprocessors, which may include a single processor, or multiple processors in combination. The processor and the memory can be supplemented by, or incorporated in, ASICs. Generally, a processor will receive instructions and data from a data store, such as a read-only memory (ROM), a random access memory (RAM), or both.

Generally, a computer will also include, or be operatively coupled to communicate with, one or more mass storage devices for storing data files. Storage devices suitable for tangibly embodying computer program instructions and data may include volatile and/or non-volatile memory (NVM), which may include, but is not limited to, semiconductor memory devices (e.g., RAM, EPROM, EEPROM, NAND flash, NOR flash, thumb drives), magnetic disks (e.g., hard disc drives), magneto-optical and/or optical media (e.g., CD, DVD).

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse, stylus, or a trackball by which the user can provide input to the computer.

In various embodiments, systems may communicate using suitable communication methods, equipment, and techniques. For example, some systems may communicate with a portable computer, network server, or other device using point-to-point communication in which a message is transported directly from the source to the receiver over a dedicated physical link (e.g., fiber optic link, point-to-point wiring, and daisy-chain). Other embodiments may transport messages by broadcasting to all or substantially all devices that are coupled together by a communication network, for example, by using using-directional radio frequency (RF) signals, while still other embodiments may transport messages characterized by high directivity, such as RF signals transmitted using directional (e.g., narrow beam) antennas or infrared signals that may optionally be used with focusing optics. Still other embodiments are possible using appropriate interfaces and protocols such as, by way of example and not intended to be limiting, RS-232, RS-422, RS-485, 802.11a/b/g, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

In some embodiments, each memory may be programmed with the same information and be initialized with substantially identical information stored in non-volatile volatile memory. In other embodiments, one or more devices may be custom configured to perform specific functions.

The detailed descriptions and figures of each of the references listed below are herein incorporated by reference. It will be understood that the functionalities described herein may be implemented in any of the hardware and/or software environments described in these references. It will also be understood that the functionalities described herein may be optionally combined with the functionalities described in these references by deploying/integrating the system described herein in an environment that permits integration of the functionalities described in the reference. It will further be understood that any characterization of “the invention” contained in the references does not apply to the instant disclosure, but rather reflects what the inventors listed on the other patents and applications considered to be their invention(s). Furthermore, to the extent any of the incorporated references characterize a feature, element, or step as being critical, necessary or important, it will be understood that such a characterization does not apply to the system described herein unless specifically indicated. With the foregoing exceptions, the detailed descriptions and figures of each of the following patents and applications is herein incorporated by reference for all purposes: U.S. Pat. No. 6,539,318, “Streaming Architecture for Waveform Processing,” by Miller et al; U.S. patent application Ser. No. 09/988,416, “Processing Web for Data Processing in a Digital Oscilloscope or Similar Instrument,” by Miller et al.; and, U.S. patent application Ser. No. 09/988,416, “Processing Web Editor for Data Processing in a Digital Oscilloscope or Similar Instrument,” by Cake et al.

For example, various embodiments may be implemented by a user defining parameters for a set of processes to be performed on a sampled waveform. The user may define the parameters to using a graphical processing web tool being presented on a user interface associated with a digital oscilloscope. In some examples, the processes may comprise multiple processing steps that combine at least two sampled waveforms, for example. In some cases, the output waveform may be processed by requesting that chunks of input waveform data be pulled through the processing steps, in accordance with a streaming architecture, for example.

Although various embodiments have been described with respect to oscilloscopes, embodiments of the described systems and methods may be implemented in other waveform processors and other applications. Exemplary applications may include, but are not limited to, logic analyzers, serial data analyzers, protocol analyzers, digital oscilloscopes, digital storage oscilloscopes, power meters, data encoding and/or decoding, cryptographic equipment, spectrum analyzers, high data rate receivers, optical receiving and analysis equipment, and combinations of these or other test, measurement, communication, or signal processing equipment.

A number of implementations have been described. Nevertheless, it will be understood that various modifications may be made without departing from the spirit and scope. For example, advantageous results may be achieved if the steps of the disclosed techniques were performed in a different sequence, if components in the disclosed systems were combined in a different manner, or if the components were replaced or supplemented by other components. The functions and processes (including algorithms) may be performed in hardware, software, or a combination thereof, and some implementations may be performed on modules or hardware not identical to those described. Accordingly, other implementations are within the scope of the following claims.

1. A method for operating a waveform processing system to process one or more data sequences representing one or more corresponding input waveforms, each input waveform having one or more time characteristics defining a timing of points of the one or more of the data sequences, comprising the steps of:
providing one or more waveform processing elements, each having one or more time effect characteristics; and
calculating one or more time characteristics of an output waveform based upon the one or more time effect characteristics of the one or more waveform processing elements and the one or more time characteristics of the one or more input waveforms.

2. The method of claim 1, further comprising the step of:
determining a portion of each of the one or more input waveforms to be processed in order to generate the output waveform.

3. The method of claim 2, further comprising the step of:
determining a segment of each portion of each of the one or more input waveforms to be processed in order to generate a segment of the output waveform.

4. The method of claim 2, further comprising the steps of:
determining one or more internal processing properties of the one or more waveform processing elements; and
defining a processing procedure for each of the one or more waveform processing elements in accordance with the one or more internal processing properties to produce two or more substantially contiguous segments of the output waveform.

5. The method of claim 4, further comprising the step of:
caching information corresponding to one or more input buffer points for each of the one or more waveform processing elements to reduce required processing thereby.

6. The method of claim 5, wherein the processing required by the waveform processing elements is reduced substantially to a theoretical minimum.

7. The method of claim 5, wherein the input buffer points for each of the waveform processing elements define at least a portion of a current state of the corresponding waveform processing element.

8. The method of claim 7, further comprising the step of:
loading the cached one or more input buffer points, thereby returning the processing element to the current state corresponding to the cached input buffer points.

9. A method for operating a waveform processing system to process a plurality of data sequences representing a plurality of corresponding input waveforms, each input waveform having one or more time characteristics defining a timing of points of the plurality of the data sequences, comprising the steps of:
providing one or more waveform processing elements corresponding to each of the plurality of input waveforms, each having one or more time effect characteristics; and
calculating one or more time characteristics of an output waveform based upon the one or more time effect characteristics of the one or more waveform processing elements and the one or more time characteristics of the plurality of input waveforms.

10. The method of claim 9, further comprising the step of:
determining a portion of each of the plurality of input waveforms to be processed in order to generate the output waveform.

11. The method of claim 10, wherein the determined time characteristics of the one or more waveform processing elements corresponding to each of the plurality of input waveforms are utilized to time align the input waveforms after processing by the waveform processing elements.

12. A waveform processing system for processing one or more data sequences representing one or more corresponding input waveforms, each input waveform having one or more time characteristics defining a timing of points of the one or more of the data sequences, comprising:
one or more waveform processing elements, each having one or more time effect characteristics; and
a processor for calculating one or more time characteristics of an output waveform based upon the one or more time effect characteristics of the one or more waveform processing elements and the one or more time characteristics of the one or more input waveforms.

13. The system of claim 12, wherein the processor further determines a portion of each of the one or more input waveforms to be processed in order to generate the output waveform.

14. The system of claim 13, wherein the processor further determines a segment of each portion of each of the one or more input waveforms to be processed in order to generate a segment of the output waveform.

15. The system of claim 13, wherein the processor further determines one or more internal processing properties of the one or more waveform processing elements, and
defines a processing procedure for each of the one or more waveform processing elements in accordance with the one or more internal processing properties to produce two or more substantially contiguous segments of the output waveform.

16. The system of claim 15, further comprising:
a cache for caching information corresponding to one or more input buffer points for each of the one or more waveform processing elements to reduce required processing thereby.

17. The system of claim 16, wherein the processing required by the waveform processing elements is reduced substantially to a theoretical minimum.

18. The system of claim 16, wherein the input buffer points for each of the waveform processing elements define at least a portion of a current state of the corresponding waveform processing element.

19. The system of claim 16, wherein the processor further loads the cached one or more input buffer points, thereby returning the processing element to the current state corresponding to the cached input buffer points.
